(19) United States
(12) Patent Application Publication
(10) Pub. No.: US 2026/0209135 A1
(43) Pub. Date: Jul. 23, 2026

(54) METHOD OF FORTIFYING FERTILIZER WITH LIPO-CHITOOLIGOSACCHARIDE (LCO)

(71) Applicant: NOVOZYMES A/S, Bagsvaerd (DK)

(72) Inventors: Jalendra Kumar HAGADUR GOPAL, Bangalore (IN); Rajeev Kumar DWIWEDI, Bangalore (IN); Chinmay SARDESHPANDE, Bangalore (IN); Madhu Arenahalli NINGEGOWDA, Bangalore (IN); T. Harshavardhan VOKKALIGA, Bangalore (IN); Deepika MUDDARAJ, Bangalore (IN); Ross Forrest GILMOUR, Kuala Lumpur (MY)

(73) Assignee: NOVOZYMES A/S, Bagsvaerd (DK)

(21) Appl. No.: 19/139,241

(22) PCT Filed: Dec. 22, 2023
(86) PCT No.: PCT/EP2023/087653

§ 371 Date: Jun. 13, 2025

(30) Foreign Application Priority Data
Dec. 29, 2022 (IN) 202241076926
Dec. 12, 2023 (MY) PI2023007555

(51) Int. Cl. C05F 11/08; C05F 11/00; C05G 3/30; C05G 3/60; C05G 3/90; C05G 5/12

(52) U.S. Cl. CPC C05F 11/08; C05F 11/00; C05G 3/30; C05G 3/60; C05G 3/90; C05G 5/12

(57) ABSTRACT

The present invention relates to producing a composition comprising one or more fertilizers and one or more Lipo-chitooligosaccharide (LCOs), and optionally one or more preservatives. The present invention relates to a method for fortifying fertilizers with LCOs comprising mixing one or more fertilizers with one or more LCOs and one or more agents selected 5 from a group consisting of one or more coating agents, one or more urease inhibitors, one or more biologicals and one or more bio-stimulants.

### FIELD OF THE INVENTION

The present invention relates to fortifying one or more fertilizers with one or more Lipo-chitooligosaccharide (LCOs).

### BACKGROUND

Most fertilizers are chemicals and consist of salts and ions of major and minor plant nutrients such as ammonium nitrate (NH₄NO₃), urea (CO(NH₂)₂), calcium ammonium nitrate (Ca(NO₃)₂), ammonium sulphate [(NH₄)₂ S0₄], ammonium sulphate nitrate [(NH₄)₂SO₄ NH₄NO₃], super phosphate [Ca (H₂PO₄)₂), potassium chloride (KCl), potassium sulphate (K₂S0₄), magnesium sulphate (MgSO₄), calcium Chloride (CaCl₂)₆H₂O), ferrous sulphate (FeSO₄ 7H₂O), manganous sulphate (MnSO₄ 7H₂O), zinc sulphate (ZnSO₄ 7H₂O) etc. Most of the chemical fertilizers are synthesized or mined and modified chemically using sulphuric acids, nitric acids, etc. Such chemical fertilizers are available as granules, water soluble powders and as liquids. Being highly concentrated forms of salts and carrying traces of strong acids and other chemicals, such fertilizers need to be applied very judiciously as per the need of the soil and crop. But the institutional recommendations and farmer practices have supported and encouraged high doses of fertilization to guarantee crops yields particularly for the high yielding hybrids. The excess use of fertilizers of all kinds in soils for many decades has resulted in degradation of soil structure and massive destruction of microorganisms reducing the biological activity of the soils. Though the academia and knowledgeable farmers are aware of this phenomenon, fertilizers are unavoidable and continue as the most important and largest agricultural input which is necessary to sustain global food production.

Over many decades, researchers and ecologists have been trying to find ways to mitigate the negative effects of chemical fertilizers use and to make them safer for the agricultural and broader environment. Slow-release technology was one huge advancement which increased the efficiency of applied fertilizers by ensuring that the active ingredients are released slowly and thereby reduce leaching losses and allows the fertilizers to be available to crops for a longer duration to absorb. The slow-release technology does not prevent, but only slows down the negative effects of the fertilizers. The slow-release technology also introduces new chemistries into the soil such as synthetic polymers (plastics) which are not biodegradable, and in turn may create more issues for the environment. In addition, the cost of the slow-release technology is higher, and the performance is variable and currently not safe to add any real value to soil ecosystem, farmers, and environment.

Fertilizers, being the largest agricultural input, globally, and applied for all crop plants, mostly in soils at the time of planting, can serve as a carrier for other agricultural inputs. These other soil and crop inputs may include naturally occurring plant growth promoting substances such as humic acids, seaweed extracts, composted or treated vegetable and animal wastes, plant growth regulators, microorganisms, bio-stimulant molecules, and other agrochemicals. Many attempts were made to combine naturally occurring plant growth promoting substances with fertilizers, to add value and make them more effective, however, were not successful primarily due to the compatibility issues with the fertilizer chemistry, timing, and dosage mismatches. In addition, loading additional inputs in the fertilizers is challenging during the manufacturing process due to extreme conditions of temperatures and harsh chemicals. The naturally occurring plant growth promoting substances also makes the final product more expensive. Government regulations are another challenge if naturally occurring plant growth promoting substances are to be used as an input combined with the fertilizers.

Nitrogen (N) based fertilizers play key role compared to other nutrients phosphorous (P) and potassium (K). In the fertilizer industry segment, among the N-fertilizers, urea has a major industry share worldwide accounting to 55% of the total N fertilizers. Benefits of urea for industrial production is that urea constitutes high N content (46%) and relatively lower manufacturing costs. However, there are disadvantages of using urea at consumer level. When urea is applied to soil, the urea is acted on by urease enzyme present in soil and hydrolysed instantly to produce ammonia (NH3), which is lost in the atmosphere. Due to this, the availability of N for plants is reduced and the pH of the soil is increased. Ammonia volatilization also causes environmental issues.

About 50% or more of nitrogen in urea is lost as ammonia gas due to the action of urease enzyme in soils. To prevent the loss of nitrogen, urease inhibitors are added to urea and other N-containing fertilizers to increase N-use efficiency for crops. Most used commercial urease inhibitor is N-(n-butyl) thiophosphoric triamide (NBPT) and/or N-(n-propyl) thio-phosphoric triamide (NPPT). Once applied to soil, NBPT converts to active N-(n-Butyl) phosphoric triamide (NBPTO), which is the actual inhibitor of urease enzyme activity. Since NBPTO chemically mimics urea, the compound binds the urease enzyme's active site and inactivates the enzyme slowing down urea hydrolysis.

Thus, there is a need for modern technologies and interventions that can make fertilizers more efficient, safe, biologically active, and agronomically more productive with less side effects on soil and environment.

### SUMMARY OF THE CLAIMED INVENTION

The present invention relates to fortifying fertilizers with one or more LCOs.

In one aspect, the present invention relates to a composition comprising one or more fertilizers and one or more LCOs.

In another aspect, the present invention relates to a method for producing a LCO fortified fertilizer comprising mixing one or more fertilizers with one or more LCOs and one or more agents selected from a group consisting of one or more coating agents, one or more urease inhibitors, one or more biologicals and one or more bio-stimulants.

In yet another embodiment, the present invention relates to a method for producing a LCO fortified fertilizer comprising a) mixing one or more LCOs with one or more agents selected from a group consisting of one or more coating agents, one or more urease inhibitors, one or more biologicals and one or more bio-stimulants; and b) spraying or mixing the one or more agents with LCO on one or more fertilizers.

### BRIEF DESCRIPTION OF THE DRAWINGS

A more complete understanding of the present invention may be derived by referring to the detailed description and claims when considered in connection with the Figures.

FIG. 1 represents a graph showing mean cabbage circumferences that were treated with water-soluble fertilizers (WSFs) only, WSFs fortified with different LCO concentrations with proxel and WSFs fortified with different LCO concentrations without proxel.

FIG. 2 represents a graph showing yield of cabbages treated with water-soluble fertilizers (WSFs) only, WSFs fortified with different LCO concentrations with proxel and WSFs fortified with different LCO concentrations without proxel.

FIG. 3 represents a graph showing number of fruits per plot of capsicum that were treated with water-soluble fertilizers (WSFs) only, WSFs fortified with different LCO concentrations with proxel and WSFs fortified with different LCO concentrations without proxel.

FIG. 4 represents a graph showing yield of capsicum treated with water-soluble fertilizers (WSFs) only, WSFs fortified with different LCO concentrations with proxel and WSFs fortified with different LCO concentrations without proxel.

FIG. 5 represents a graph showing epicotyl length and shoot length measured from 10-day old beans seedlings treated with LCO only, water-soluble fertilizers (WSFs) only, WSFs fortified with LCO.

FIG. 6 represents a graph showing mean cabbage circumferences that were treated with granular fertilizers (GFs) only, GFs fortified with different LCO concentrations with proxel, and GFs fortified with different LCO concentrations without proxel.

FIG. 7 represents a graph showing yield of cabbages treated with granular fertilizers (GFs) only, GFs fortified with different LCO concentrations with proxel, and GFs fortified with different LCO concentrations without proxel.

FIG. 8 represents a graph showing plant height of corns treated with granular fertilizers (GFs) only, GFs fortified with different LCO concentrations with proxel, and GFs fortified with different LCO concentrations without proxel.

FIG. 9 represents a graph showing chlorophyll content and stem girth of corns treated with granular fertilizers (GFs) only, GFs fortified with different LCO concentrations with proxel, and GFs fortified with different LCO concentrations without proxel.

FIG. 10 represents a graph showing cob number, cob dry weight and grain weight of corns treated with granular fertilizers (GFs) only, GFs fortified with different LCO concentrations with proxel, and GFs fortified with different LCO concentrations without proxel.

FIG. 11 represents a graph showing average shoot length of corn seedlings: treated with WSF, treated with WSF+LCO, treated with WSF fortified with UI+LCO, treated with WSF+UI, after 20 DAS.

FIG. 12 represents a graph showing average shoot length of corn seedlings: treated with urea, treated with urea+LCO, treated with urea fortified with UI+LCO, treated with urea+UI, after 20 DAS.

FIG. 13 represents a graph showing average chlorophyll content of corn seedlings: treated with WSF, treated with WSF+LCO, treated with WSF fortified with UI+LCO, treated with WSF+UI, after 20 DAS.

FIG. 14 represents a graph showing average chlorophyll content of corn seedlings: treated with urea, treated with urea+LCO, treated with urea fortified with UI+LCO, treated with urea+UI, after 20 DAS.

FIG. 15 represents a graph showing average root dry weight of corn seedlings: treated with WSF, treated with WSF+LCO, treated with WSF fortified with UI+LCO, treated with WSF+UI.

FIG. 16 represents a graph showing average root dry weight of corn seedlings: treated with urea, treated with urea+LCO, treated with urea fortified with UI+LCO, treated with urea+UI.

FIG. 17 represents a graph showing average leaf dry weight of corn seedlings: treated with WSF, treated with WSF+LCO, treated with WSF fortified with UI+LCO, treated with WSF+UI.

FIG. 18 represents a graph showing average leaf dry weight of corn seedlings: treated with urea, treated with urea+LCO, treated with urea fortified with UI+LCO, treated with urea+UI.

FIG. 19 represents a graph showing average leaf area of corn seedlings: treated with WSF, treated with WSF+LCO, treated with WSF fortified with UI+LCO, treated with WSF+UI.

FIG. 20 represents a graph showing average leaf area of corn seedlings: treated with urea, treated with urea+LCO, treated with urea fortified with UI+LCO, treated with urea+UI.

FIG. 21 represents a graph showing total nitrogen in 20 days old corn seedlings: treated with WSF, treated with WSF+LCO, treated with WSF fortified with UI+LCO, treated with WSF+UI.

FIG. 22 represents a graph showing total nitrogen in 20 days old corn seedlings: treated with urea, treated with urea+LCO, treated with urea fortified with UI+LCO, treated with urea+UI.

FIG. 23 represents a graph showing nitrogen use efficiency in 20 days old corn seedlings: treated with WSF, treated with WSF+LCO, treated with WSF fortified with UI+LCO, treated with WSF+UI.

FIG. 24 represents a graph showing nitrogen use efficiency in 20 days old corn seedlings: treated with urea, treated with urea+LCO, treated with urea fortified with UI+LCO, treated with urea+UI.

FIG. 25 represents a graph showing available nitrogen in soil samples from the corn pots: treated with WSF, treated with WSF+LCO, treated with WSF fortified with UI+LCO, treated with WSF+UI, after 20 DAS.

FIG. 26 represents a graph showing available nitrogen in soil samples from the corn pots: treated with urea, treated with urea+LCO, treated with urea fortified with UI+LCO, treated with urea+UI.

FIG. 27 represents a graph showing number of root hairs in seedlings of ragi @ 3 DAS: untreated control (UTC) and treated with LCO.

FIG. 28 represents a graph showing root length measured @ 10 DAS in beans, horse gram and green gram seedlings: untreated control and treated with LCO.

FIG. 29 represents a graph showing root length measured @ 4 DAS in ragi and rice seedlings: untreated control and treated with LCO.

FIG. 30 represents a graph showing cabbage yield per plot: Control (only bulk granular fertilizer_BGF), and BGF+LCO.

FIG. 31 represents a graph showing average head volume of cabbages in the plots: BGF and BGF+LCO.

FIG. 32 represents a graph showing number of cobs per plot of corn: BGF and BGF+LCO.

FIG. 33 represents a graph showing grain yield per plot of corn: BGF and BGF+LCO.

FIG. 34 represents a graph showing average chilly fruit yield per plot: untreated control-bentonite, Mycorrhiza, and LCO fortified Mycorrhiza.

FIG. 35 represents a graph showing chilly fruit yield per plot: untreated control-bentonite, bio-stimulant, and LCO fortified bio-stimulant.

FIG. 36 represents a graph showing potato tuber yield per plot: untreated control-bentonite, bio-stimulant, and LCO fortified bio-stimulant.

FIG. 37 represents a graph showing potato tuber yield per plot: untreated control-bentonite, Mycorrhiza, and LCO fortified Mycorrhiza.

FIG. 38 represents a graph showing wheat grain yield per plot: untreated control, Phosphorus solubilizing bacteria (PSB), LCO+PSB, Mycorrhiza, LCO+Mycorrhiza.

FIG. 39 represents a graph showing shoot length of corn plants: BGF, BGF+LCO, BGF+NPK constortia, BGF+biostimulant, BGF+biostimulant+LCO

FIG. 40 represents a graph showing shoot dry weight of corn plants: BGF, BGF+LCO, BGF+NPK constortia, BGF+biostimulant, BGF+biostimulant+LCO

FIG. 41 represents a graph showing root dry weight of corn plants: BGF, BGF+LCO, BGF+NPK constortia, BGF+biostimulant, BGF+biostimulant+LCO

FIG. 42 represents a graph showing leaf area of corn plants: BGF, BGF+LCO, BGF+NPK constortia, BGF+biostimulant, BGF+biostimulant+LCO

### DEFINITIONS

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For the sake of brevity and/or clarity, well-known functions or constructions may not be described in detail.

As used herein, the singular forms “a,” “an,” and “the” are intended to include the plural forms as well, unless the context clearly indicates otherwise.

Throughout this disclosure, unless the context requires otherwise, the words “comprise,” “comprises,” and “comprising” will be understood to imply the inclusion of a stated step or element or group of steps or elements but not the exclusion of any other step or element or group of steps or elements.

The term “consisting of” means including, and limited to, whatever follows the phrase “consisting of.” Thus, the phrase “consisting of” indicates that the listed elements are required or mandatory, and that no other elements may be present. The term “consisting essentially of” means including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

As used herein, the term “water-soluble fertilizers” are fertilizers in powder form that dissolve in water and applied to the plant through fertigation and foliar application to increase nutrient use efficiency.

As used herein, the term “granular fertilizer” is fertilizers in granular form either as regular or irregular spherical granules or pellets, which are applied to soil at the time of planting as basal application or later during the crop growth phase as top dress, to supply nutrients to the plants.

As used herein, the term “liquid fertilizer” is a liquid solution that can provide nutrients to plants. Liquid fertilizers can be defined broadly as concentrated liquids containing essential plant nutrients, including macro and micronutrients, which are mixed with water and applied to soil or plant foliage. These nutrients could be synthetic or biological in origin.

As used herein, the term “coating agent” is an additive added to fertilizers to prevent clumping of the fertilizers.

As used herein, the term “anticaking agent” is an additive added to powder or granulated materials such as fertilizers to prevent clumping of particles and to retain flowability which helps in packaging, storage, and use.

As used herein, the term “urease inhibitor” is a chemical compound that blocks the activity of the enzyme urease.

As used herein, the term “biologicals” are a group of agricultural inputs which includes living organisms or products derived from living organisms such as biofertilizers, biocontrol agents, biopesticides and bio-stimulants.

As used herein, the term “bio-stimulant” is a compound that stimulates growth and health of a plant.

While certain embodiments of the present disclosure will hereinafter be described with reference to embodiments thereof, it will be understood by those of ordinary skill in the art that various changes in form and details may be made therein without departing from the spirit and scope of the present invention as defined by the claims.

### DETAILED DESCRIPTION OF THE INVENTION

The present invention relates to fortifying one or more fertilizers with one or more LCOs.

The inventors identified with the present invention that when fertilizers fortified with LCOs are used as agricultural inputs, there is increase in growth and yield of the plants when compared to fertilizer not fortified with LCOs.

### Composition

In one embodiment of the present invention, a composition comprises one or more fertilizers, one or more Lipo-chitooligosaccharides (LCOs) and optionally one or more preservatives.

In an embodiment of the composition, the one or more fertilizers is water-soluble fertilizers, granular fertilizers, or liquid fertilizers. In an embodiment of the composition, the water-soluble fertilizer are macronutrients and/or micronutrients. In an embodiment of the composition, the macronutrient is selected from a group comprising of nitrogen:phosphorous:potassium (NPK), calcium nitrate, urea phosphate, potassium nitrate, urea, mono potassium phosphate, sulphate of potash, nitrogen:phosphorous:potassium:sulphur:calcium:boron (NPKSCaB), NPKSB, mono ammonium phosphate, urea sulphate of potash and sulphur, and sulphate of potash with sulphur. In an embodiment, the water-soluble fertilizer can be any NPK complex of varying proportions as listed in Table 1 below. In an embodiment of the method, the micronutrient of water-soluble fertilizers is selected from a group consisting of boron, zinc sulphate, sulphur bentonite, magnesium sulphate, chelated forms of iron, chelated forms of zinc, chelated forms of magnesium, and chelated forms of calcium. Table 2 lists the different forms of micronutrients. In an embodiment of the composition, the water-soluble fertilizer can be a mixture or combination of macronutrients and micronutrients as listed in tables 1 and 2.

TABLE 1

| | Water Soluble Macronutrient formulations or grades for Soil drench, |
|---|---|
| Macronutrients | In furrow application and foliar applications |
| N—P—K—S—Ca—B | Nitrogen:Phosphorous:Potassium:Sulphur:Calcium:Boron |
| 19-19-19 | NPK |
| 17-44-00 | Urea Phosphate |
| 13-0-45 | Potassium Nitrate |
| 0-52-34 | Mono Potassium Phosphate |
| 0-0-50 | Sulphate of Potash |
| 12-61-0 | Mono Ammonium Phosphate |
| 15.5-0-0-0-18.5 | Calcium Nitrate. |
| 27-0-0-0-0-5 | Calcium ammonium nitrate |
| 18-18-18-6.1 | Urea Sulphate of Potash and Sulphur |
| 0-0-50-17.5 | Sulphate of Potash with Sulphur |
| 13-40-13 | NPK |
| 0-60-20 | NPK |
| 9-27-18-7.5 | NPKS&B |
| 46-0-0 | Urea |

TABLE 2

| | Water Soluble Micronutrient formulations or grades for Soil drench, |
|---|---|
| Micronutrients | In furrow application and foliar applications |
| Boron | Sodium tetraborate penta hydrate/Disodium octaborate tetrahydrate |
| Zn—S | Zinc Sulphate monohydrate/Heptahydrate |
| S | Sulphur Bentonite |
| Mg—S | Magnesium Sulphate |
| Fe-Chelated | All Chelated forms of iron such as FE-EDTA, FE-EDDA, etc |
| Zn-Chelated | All chelated forms of Zinc such as Zn-EDTA |
| Mg-Chelated | All chelated forms of Zinc such as Mg-EDTA |
| Ca-Chelated | All chelated forms of Zinc such as Ca-EDTA |
| Combinations | All different combinations of micronutrients used as foliar or infurrow/soil |
| | drench |

In an embodiment of the composition, the granular fertilizer is selected from a group consisting of complex fertilizers, straight fertilizers, and micronutrients of granular fertilizer. In an embodiment, the one or more complex fertilizers is selected from a group consisting of nitrogen:phosphorous:potassium (NPK), nitrogen:phosphorous:potassium:sulphur (NPKS+S), nitrogen:phosphorous:potassium:magnesium (NPK+Mg), nitrophosphate with potash, diammonium phosphate (DAP) granules, ammonium phosphate sulphate, ammonium phosphate sulphate nitrate, nitrophosphate, urea ammonium phosphate, mono ammonium phosphate, ammonium nitrate phosphate and ammonium phosphate. The granular fertilizer can be any NPK complex of varying proportions as listed in Table 3 below.

TABLE 3

| Complex fertilizers | Composition |
|---|---|
| 10-26-26 | Nitrogen (N)- Phosphorous(P)- Potassium(K) |
| 12-32-16 | NPK |
| 22-22-11 | NPK |
| 14-35-14 | NPK |
| 17-17-17 | NPK |
| 14-28-14 | NPK |
| 19-19-19 | NPK |
| 20-10-10 | NPK |
| 15-15-15 | NPK |
| 16-16-16 | NPK |
| 9-25-25 | NPK |
| 15-15-15-9 (S) | NPK + S (Sulphur) |
| 13-33-0-15 (S) | NPK + S (Sulphur) |
| 12-11-18 with MgO | NPK + Mg (Magnesium) |
| 14-14-21 | Nitrophopshate with Potash |
| 21-06-13 | Nitrophopshate with Potash |
| 15-15-15 GradeII | Nitrophopshate with Potash |
| 15-15-15 | Nitrophosphate with Potash |
| 15-9-20 | Nitrophopshate with Potash |
| 18-46-0 | Diammonium Phosphate (DAP) Granules |
| 16-20-0 | Ammonium Phosphate Sulphate |
| 20-20-0 | Ammonium Phosphate Sulphate |
| 20-20-0 | Ammonium Phosphate Sulphate Nitrate |
| 20-20-0 | Nitrophosphate |
| 24-24-0 | Nitrophosphate |
| 28-28-0 | Urea Ammonium Phosphate |
| 24-24-0 | Urea Ammonium Phosphate |
| 20-20-0 | Urea Ammonium Phosphate |
| 11-52-0 | Mono Ammonium Phosphate |
| 23-23-0 | Ammonium Nitrate Phosphate |
| 14-28-0 | Ammonium Phosphate |

In another embodiment, the one or more straight fertilizers is selected from a group consisting of urea granules, urea super granules, urea briquettes, ammonium sulphate granules, calcium ammonium nitrate granules, ammonium chloride granules, single super phosphate granules, rock phosphate granules, murate of potash (KCl) granules, potassium sulphate granules, potassium magnesium sulphate granules and granulated sulphur. Table 4 lists the different forms of straight granular fertilizers.

TABLE 4

| Straight Fertilizers | Constituents |
|---|---|
| Urea Granular | 46% Nitrogen |
| Urea Super Granules | 46% Nitrogen |
| Urea Briquettes | 46% Nitrogen |
| Ammonium Sulphate granules | Nitrogen |
| Calcium Ammonium nitrate granules | Nitrogen, Calcium |
| Ammonium Chloride granules | Nitrogen |
| Single Super Phosphate Granulated | 14% water soluble Phosphate (P2O5) |
| Rock Phosphate granular | Phosphorous (18%) |
| Murate of potash (KCl) granular | Potassium (60%) |
| Potassium Sulphate granular | Potassium (50%), Sulphate (17.5%) |
| Potassium Magnesium Sulphate | Potassium (30%), Magnesium (10%), Sulphur |
| granules | (17%) |
| Granulated Sulphur | Sulphur (90%) |

In another embodiment, the one or more micronutrients in the granular fertilizers is selected from a group consisting of zinc sulphate hepta hydrate, zinc phosphate, manganese sulphate, borax, sodium tetraborate, boric acid, di-sodium tetraborate penta hydrate, copper sulphate, ferrous sulphate, magnesium sulphate, magnesium hydroxide, ammonium molybdate, and chelated zinc. Table 5 lists the different forms of micronutrients of granular fertilizers.

TABLE 5
Micronutrients: One or combinations of micronutrients
in granular form, or combined with granular macronutrients
can be fortified with LCO

Zinc sulphate hepta hydrate, Zinc Phosphate,
Manganese sulphate
Borax or sodium tetraborate, Boric acid, di-sodium
tetraborate penta hydrate
Copper sulphate
Ferrous Sulphate
Magnesium Sulphate, Magnesium Hydroxide
Ammonium Molybdate
Chelated Zinc

In an embodiment of the composition, the granular fertilizer can be a mixture or combination of complex fertilizer, straight fertilizers and micronutrients as listed in Tables 3, 4 and 5.

In an embodiment of the composition, the liquid fertilizer is various combinations of macro nutrients such as salts and/or ions of Nitrogen, Phosphorous, Potassium and micro-nutrients such as sulphur, calcium, magnesium, boron, zinc, iron, manganese, copper, molybdenum, chlorine, selenium, etc.

In an embodiment of the composition, the LCO is represented by a structure:

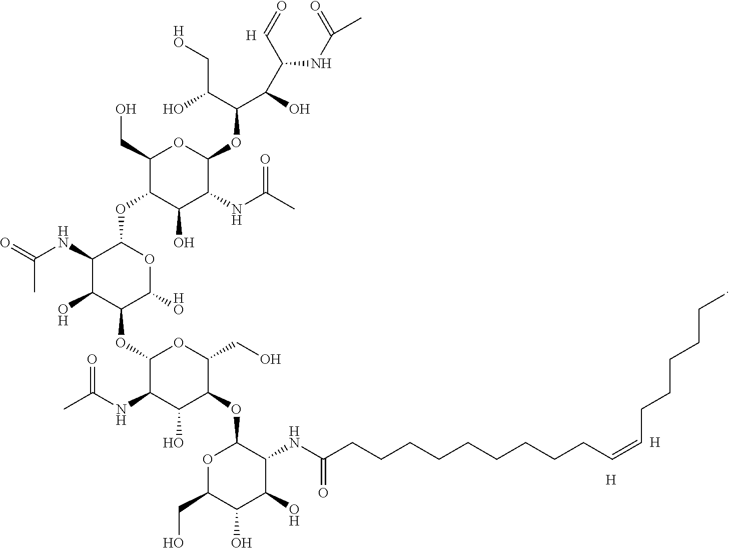

In an embodiment of the composition, the one or more preservatives is selected from a group consisting of sodium benzoate, calcium sorbate, and dipropylene glycol solution of 1,2-benzisothiazolin-3 and other such compounds. For example, dipropylene glycol solution of 1,2-benzisothiazolin-3 which is commercially known as Proxel.

In an embodiment of the composition, the coating agent is an anticaking agent. The anticaking agents are additives added to fertilizers to prevent clumping of particles and to retain flowability which helps in packaging, storage, and use. Depending on the end use, the anticaking agents are formulated to be water soluble or oil soluble. In another embodiment, the anticaking agent is selected from a group consisting of tricalcium phosphate, powdered cellulose, magnesium stearate, sodium bicarbonate, sodium ferrocyanide, potassium ferrocyanide, calcium ferrocyanide, calcium phosphate, sodium silicate, silicon dioxide, calcium silicate, magnesium trisilicate, talcum powder, sodium aluminosilicate, potassium aluminium silicate, calcium aluminosilicate, bentonite, aluminium silicate, stearic acid, polydime thylsiloxane, slack wax and/or mineral oil along with fatty amines of varied hydrocarbon chain length. The fatty amines help to reduce hygroscopicity of fertilizers leading to decreased caking, and thus the fatty amines are critical. In an embodiment, the composition comprises at least 0.5-4 kg of anticaking agent per ton of water-soluble fertilizers. In a preferred embodiment, the composition comprises at least 2 kg of anticaking agent per ton of water-soluble fertilizers.

In an embodiment of the composition, the composition comprises 0.050-0.150 parts per billion (ppb) of LCO in water-soluble fertilizers.

In an embodiment of the composition, the composition comprises 0.030-0.10 parts per billion (ppb) of LCO in granular fertilizers.

In a further embodiment of the composition, the composition further comprises one or more urease inhibitors. In a preferred embodiment of the composition, the one or more urease inhibitors is N-(n-butyl) thiophosphoric triamide (NBPT) and/or N-(n-propyl) thio-phosphoric triamide (NPPT).

Urease is an enzyme produced by soil microbes that hydrolyse urea into ammonia gas and carbon dioxide. Some of that ammonia can become ammonium ion when bound to a proton (H+ ion) or on the cation exchange sites of clay particles. About 50% or more of Nitrogen in Urea is lost as ammonia gas due to the action of Urease enzyme in soils, as per the studies. To prevent the loss of Nitrogen, urease inhibitors are added to urea and other N-containing fertilizers to increase its N-use efficiency and prevent losses.

The LCO can increase root length and root hairs in the first 3 days when urease inhibitor also has the maximum benefit until the first 7-14 days after application. Both urease inhibitor and LCO have distinct functions and the combination supports the sequential steps involved in nitrogen uptake. Urease inhibitor inhibits the urease enzyme activity in soil and helps to reduce nitrogen losses by way of ammonification. This leads to applied nitrogen being present in soil for longer period, up to 7-14 days, for plant uptake, provided there are no leaching losses. While on the other hand, LCO triggers two functions viz., (a) increases the number and length of root hairs in the first 2 days, enhancing the surface area for absorption and (b) upregulating the nitrogen uptake pathways in the plant root cells which enhances the nitrogen uptake and nitrogen assimilation into the plant system.

The combination of both urease inhibitor and LCO that ensures higher efficiency of fertilizers by increasing nitrogen uptake and nitrogen use efficiency of the crop by (a) decreasing losses due ammonification and increasing the soil available nitrogen pool, and (b) enhanced active uptake of nitrogen due to increased surface area of absorption at root hairs and increased nitrogen assimilation. The present invention is the combination that start acting together on the seedlings immediately after application, and work in tandem until first 7-14 days, to enhance nitrogen use efficiency of crops.

Literature and industry experience suggests that performance of urease inhibitor combined with urea is highly variable in agronomic field conditions. Urease inhibitor works in soil for up to 7-14 days after application before the urease inhibitor gets degraded. The application of urease inhibitor may reduce the loss of applied urea by ammonification, but if the ‘saved nitrogen’ is not taken up by plants in the 7-14 days, the ‘saved nitrogen’ eventually gets acted upon by soil urease, and nitrogen loss begin, thus the benefit of adding urease inhibitor is less. Without any bio-stimulation, the seedlings will not take up additional nitrogen from soil, even though the nitrogen availability is high. The role of LCO becomes important here as it provides the required bio-stimulation by up-regulating the pathways related to nitrogen uptake and nitrogen assimilation along with physiological increases in root architecture and root hair volume to help higher nitrogen absorption and other nutrients. The LCO ensures that seedlings take-up more of the available nitrogen in those first 7-10 days period when urease inhibitor is fully functional in preventing losses. Thus, combining LCO with urease inhibitor results in the best paring of functions to further enhance the nitrogen use efficiency of fertilizers, over urease inhibitor alone. The LCO reduces the variability of the field performance of urease inhibitor. Combining the LCO with the urease inhibitor, makes the latter relevant and suitable for fertilizers having lower nitrogen content such as WSF grades.

In a preferred embodiment, the urease inhibitor is N-(n-butyl) thiophosphoric triamide (NBPT) and/or N-(n-propyl) thio-phosphoric triamide (NPPT). In an embodiment, the composition comprises 400 to 800 parts per million (ppm) of urease inhibitor per ton of water-soluble fertilizer. In a preferred embodiment, the composition comprises 600 parts per million (ppm) of urease inhibitor per ton of water-soluble fertilizer. In a further embodiment of the composition, the composition further comprises one or more pH stabilizer. In an embodiment, the pH stabilizer is magnesium oxide. In preferred embodiment, the composition comprises 500 to 800 ppm of urease inhibitors and 1-2 kilograms (kgs) pH stabilizer per ton of water-soluble fertilizer. NBPT is decayed at low pH within 24 hours and most fertilizers are highly acidic in pH. To overcome the decay, magnesium oxide or other cation sources are added to increase the pH and protect NBPT. The urease inhibitors are formulated in organic solvents like n-methylpyrrolidone (NMP). The organic solvents assist in protecting the NBPT molecule in storage and are integral to applying the NBPT onto the urea since the solvent spreads evenly over the urea without dissolving the urea. In an embodiment, the composition comprises 400 to 800 parts per million (ppm) of urease inhibitor per ton of fertilizer. In a preferred embodiment, the composition comprises 600 parts per million (ppm) of urease inhibitor per ton of fertilizer. In a further embodiment of the composition, the composition further comprises one or more pH stabilizer. In an embodiment, the pH stabilizer is magnesium oxide. In preferred embodiment, the composition comprises 500 to 800 ppm of urease inhibitors and 1-2 kilograms (kgs) pH stabilizer per ton of fertilizer. NBPT is decayed at low pH within 24 hours and most fertilizers are highly acidic in pH. To overcome the decay, magnesium oxide or other cation sources are added to increase the pH and protect NBPT. The urease inhibitors are formulated in organic solvents like n-methylpyrrolidone (NMP). The organic solvents assist in protecting the NBPT molecule in storage and are integral to applying the NBPT onto the urea since the solvent spreads evenly over the urea without dissolving the urea.

In an embodiment of the composition, the composition comprises 7.6-11.4 ppb of LCO in 1.0 litre per acre of liquid fertilizers.

In an embodiment of the composition, the composition further comprises one or more biologicals. The biologicals are selected from a group consisting of:
i. microbes having nutrient solubilizing and nutrient mobilizing functions;
ii. fungi, bacteria or actinomycetes that belong to class-1 and elicit function of nutrient solubilization;
iii. free living nitrogen fixing bacteria;
iv. phosphorous mobilizing microbes;
v. organisms or microbes for control of pests and diseases of crop plants; and

The fungi, bacteria or actinomycetes are those which elicit function of solubilization of Phosphorous (Fungal and Bacteria spp), Potassium (Bacterial spp), Calcium (Bacteria spp), Zinc (Bacteria spp), Iron (solubilizing and siderophore producing Bacteria spp), Magnesium (Bacteria spp), Manganese (Bacteria spp), Boron (Bacteria spp). The free-living nitrogen fixing bacteria are selected from a group consisting of Azospirillum, Azotobacter, Bejerinckia, Rhodospirillum, etc. The phosphorus mobilizing microbe is Mycorrhiza (fungi) or other fungi of the Basidiomycota group such as Sebacinales.

In an embodiment of the composition, the composition further comprises one or more bio-stimulants. The bio-stimulants are selected from a group consisting of humates and humic acids, fulvic acids, lignin, seaweeds and seaweed extracts and other plant and microbial extracts that promote plant growth and development, synthetic, natural or nature identical plant growth regulating substances or plant immunity triggering or enhancing substances and plant protection substances or biocides. The synthetic, natural or nature identical plant growth regulating substances include auxins, gibberellins, cytokinins, abscisic acids, ethylene, brassinosteroids, plant immunity response triggering compounds such as jasmonic acids, salicylic acids, phenols, chitins, microbial toxins, chemical ligands, drugs, etc.

The present invention further relates to a method of fortifying fertilizers with LCO comprises mixing one or more fertilizers with one or more LCOs and one or more agents selected from a group consisting of one or more coating agents, one or more urease inhibitors, one or more biologicals and one or more bio-stimulants.

In an embodiment of the method, the method comprises mixing one or more LCOs with one or more agents selected from a group consisting of one or more coating agents, one or more urease inhibitors, one or more biologicals and one or more bio-stimulants; and spraying or mixing the agents with LCOs on one or more fertilizers.

In an embodiment of the method, the LCO is represented by a structure:

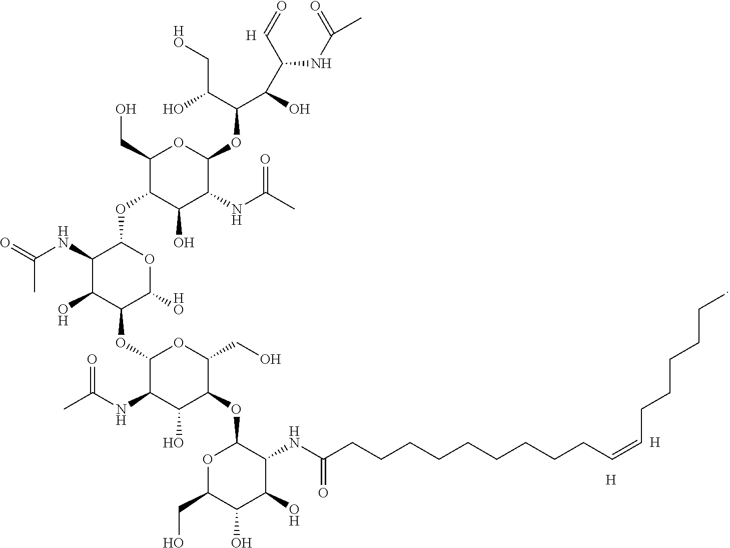

In an embodiment of the method, the one or more fertilizers is water-soluble fertilizers, granular fertilizers, or liquid fertilizers.

In an embodiment of the method, the water-soluble fertilizer are macronutrients, micronutrients, or combinations of both. In an embodiment of the method, the macronutrient is selected from a group comprising of nitrogen:phosphorous:potassium (NPK), calcium nitrate, urea phosphate, potassium nitrate, urea, mono potassium phosphate, sulphate of potash, nitrogen:phosphorous:potassium:sulphur:calcium:boron (NPKSCaB), NPKSB, mono ammonium phosphate, urea sulphate of potash and sulphur, and sulphate of potash with sulphur. In an embodiment, the water-soluble fertilizer can be any NPK complex of varying proportions as listed in Table 1 above. In an embodiment of the method, the micronutrient is selected from a group consisting of boron, zinc sulphate, sulphur bentonite, magnesium sulphate, chelated forms of iron, chelated forms of zinc, chelated forms of magnesium, and chelated forms of calcium. Table 2 lists the different forms of the micronutrients.

In an embodiment of the method, the granular fertilizer is selected from a group consisting of complex fertilizers, straight fertilizers, and micronutrients of granular fertilizer. In an embodiment, the one or more complex fertilizers is selected from a group consisting of nitrogen:phosphorous:potassium (NPK), nitrogen:phosphorous:potassium:sulphur (NPKS+S), nitrogen:phosphorous:potassium:magnesium (NPK+Mg), nitrophosphate with potash, diammonium phosphate (DAP) granules, ammonium phosphate sulphate, ammonium phosphate sulphate nitrate, nitrophosphate, urea ammonium phosphate, mono ammonium phosphate, ammonium nitrate phosphate and ammonium phosphate. The granular fertilizer can be any NPK complex of varying proportions as listed in Table 3 above.

In another embodiment of the method, the one or more straight fertilizers is selected from a group consisting of urea granules, urea super granules, urea briquettes, ammonium sulphate granules, calcium ammonium nitrate granules, ammonium chloride granules, single super phosphate granules, rock phosphate granules, murate of potash (KCl) granules, potassium sulphate granules, potassium magnesium sulphate granules and granulated sulphur. Table 4 above lists the different forms of straight granular fertilizers.

In another embodiment of the method, the one or more micronutrients in the granular fertilizers is selected from a group consisting of zinc sulphate hepta hydrate, zinc phosphate, manganese sulphate, borax, sodium tetraborate, boric acid, di-sodium tetraborate penta hydrate, copper sulphate, ferrous sulphate, magnesium sulphate, magnesium hydroxide, ammonium molybdate, and chelated zinc. Table 5 above lists the different forms of micronutrients of granular fertilizers.

In an embodiment of the method, the liquid fertilizer is various combinations of macro nutrients such as salts and/or ions of Nitrogen, Phosphorous, Potassium and micro-nutrients such as sulphur, calcium, magnesium, boron, zinc, iron, manganese, copper, molybdenum, chlorine, selenium, etc.

In an embodiment of the method, the coating agent is an anticaking agent. In another embodiment, the anticaking agent is selected from a group consisting of tricalcium phosphate, powdered cellulose, magnesium stearate, sodium bicarbonate, sodium ferrocyanide, potassium ferrocyanide, calcium ferrocyanide, calcium phosphate, sodium silicate, silicon dioxide, calcium silicate, magnesium trisilicate, talcum powder, sodium aluminosilicate, potassium aluminium silicate, calcium aluminosilicate, bentonite, aluminium silicate, stearic acid, polydime thylsiloxane, slack wax and/or mineral oil along with fatty amines of varied hydrocarbon chain length. The fatty amines help to reduce hygroscopicity of fertilizers leading to decreased caking, and thus the fatty amines are critical.

In an embodiment, the composition comprises at least 0.5-4 kg of anticaking agent per ton of water-soluble fertilizers. In a preferred embodiment, the composition comprises at least 2 kg of anticaking agent per ton of water-soluble fertilizers.

In an embodiment of the method, the one or more fertilizers is water-soluble fertilizers, granular fertilizers, or liquid fertilizers.

In an embodiment of the method, the urease inhibitor is N-(n-butyl) thiophosphoric triamide (NBPT) and/or N-(n-propyl) thio-phosphoric triamide (NPPT). In an embodiment, the method comprises spraying or mixing 400 to 800 parts per million (ppm) of urease inhibitor per ton of fertilizer.

In an embodiment of the method, method comprises spraying 600 parts per million (ppm) of the urease inhibitors per ton of the water-soluble fertilizer.

In an embodiment of the method, the method further comprises adding pH stabilizer per ton of fertilizer. In a further embodiment, the method comprises adding an effective amount of pH stabilizer per ton of fertilizer. In a preferred embodiment, the pH stabilizer is magnesium oxide.

In an embodiment of the method, the one or more fertilizers is water-soluble fertilizers, granular fertilizers, or liquid fertilizers.

In an embodiment of the method, the biologicals are selected from a group consisting of:
i. microbes having nutrient solubilizing and nutrient mobilizing functions;
ii. fungi, bacteria or actinomycetes that belong to class-1 and elicit function of nutrient solubilization;
iii. free living nitrogen fixing bacteria;
iv. Phosphorous mobilizing microbes; and
v. organisms or microbes for control of pests and diseases of crop plants
   The fungi, bacteria or actinomycetes are those which elicit function of solubilization of Phosphorous (Fungal and Bacteria spp), Potassium (Bacterial spp), Calcium (Bacteria spp), Zinc (Bacteria spp), Iron (solubilizing and siderophore producing Bacteria spp), Magnesium (Bacteria spp), Manganese (Bacteria spp), Boron (Bacteria spp). The free-living nitrogen fixing bacteria are selected from a group consisting of Azospirillum, Azotobacter, Bejerinckia, Rhodospirillum, etc. The phosphorus mobilizing microbe is Mycorrhiza (fungi) or other fungi of the Basidiomycota group such as Sebacinales.

In yet another embodiment of the method, the bio-stimulants are selected from a group consisting of humates and humic acids, fulvic acids, lignin, seaweeds and seaweed extracts and other plant and microbial extracts that promote plant growth and development, synthetic, natural or nature identical plant growth regulating substances or plant immunity triggering or enhancing substances and plant protection substances or biocides. The synthetic, natural or nature identical plant growth regulating substances include auxins, gibberellins, cytokinins, abscisic acids, ethylene, brassinosteroids, plant immunity response triggering compounds such as jasmonic acids, salicylic acids, phenols, chitins, microbial toxins, chemical ligands, drugs, etc.

In an embodiment of the method, the method further comprises adding one or more preservatives. The one or more preservatives is selected from a group consisting of sodium benzoate, calcium sorbate, and dipropylene glycol solution of 1,2-benzisothiazolin-3 and other such compounds. For example, dipropylene glycol solution of 1,2-benzisothiazolin-3 which is commercially known as Proxel.

In an embodiment of the method, the LCO fortified fertilizer comprises 0.050-0.150 ppb of LCO in water-soluble fertilizers. In an embodiment of the method, the LCO fortified fertilizer comprises 0.030-0.10 parts per billion (ppb) of LCO in granular fertilizers. In an embodiment of the method, the LCO fortified fertilizer comprises 7.6-11.4 ppb of LCO in 1.0 litre per acre of liquid fertilizers.

The present invention further relates to use of LCO fortified fertilizers to enhance plant growth and/or yield. In an embodiment of the use, the plant growth and/or yield comprises increased root branching, increased root hairs, enhanced nutrient use efficiency, enhanced symbiotic activity, enhanced population of PGPRs, early flowering, pro-fuse flowering, increase in fruit and/or seed sizes and numbers.

The present invention further relates to a method for enhancing plant growth and/or yield comprising applying an effective amount of LCO fortified fertilizers to plant, plant part, plant seed and/or soil.

Particular embodiments of the present disclosure are described in the following numbered paragraphs:

1. A composition comprising one or more fertilizers, and one or more Lipo-chitooligosaccharide (LCOs) and optionally one or more preservative.
2. A composition according to paragraph 1, wherein the one or more fertilizers is water-soluble fertilizers, granular fertilizers, and liquid fertilizers.
3. The composition according to paragraph 2, wherein the water-soluble fertilizers is selected from a group comprising of: urea, nitrogen:phosphorous:potassium (NPK), micronutrients, calcium urea nitrate, phosphate, potassium nitrate, nitrogen:phosphorous:potassium:sulphur:calcium:boron (NPKSCaB), Mono potassium phosphate, sulphate of potash, mono ammonium phosphate, urea sulphate of potash and sulphur, sulphate of potash with sulphur, and NPKSB.
4. The composition according to paragraph 3, wherein the micronutrients in the water-soluble fertilizers is selected from a group consisting of: boron, zinc sulphate, sulphur bentonite, magnesium sulphate, chelated forms of iron, chelated forms of zinc, chelated forms of magnesium, and chelated forms of calcium.
5. The composition according to paragraph 2, wherein the one or more granular fertilizers is selected from a group consisting of:
a. one or more complex fertilizers;
b. one or more straight fertilizers; and
C. one or more micronutrients.
   6. The composition according to paragraph 5, wherein the one or more complex fertilizers is selected from a group consisting of nitrogen:phosphorous:potassium (NPK), nitrogen:phosphorous:potassium:sulphur (NPKS+S), nitrogen:phosphorous:potassium:magnesium (NPK+Mg), nitrophosphate with potash, diammonium phosphate (DAP) granules, ammonium phosphate sulphate, ammonium phosphate sulphate nitrate, nitrophosphate, urea ammonium phosphate, mono ammonium phosphate, ammonium nitrate phosphate and ammonium phosphate.
   7. The composition according to paragraph 5, wherein the one or more straight fertilizers is selected from a group consisting of urea granules, urea super granules, urea briquettes, ammonium sulphate granules, calcium ammonium nitrate granules, ammonium chloride granules, single super phosphate granules, rock phosphate granules, murate of potash (KCl) granules, potassium sulphate granules, potassium magnesium sulphate granules and granulated sulphur.
   8. The composition according to paragraph 5, wherein the one or more micronutrients in the granular fertilizers is selected from a group consisting of zinc sulphate hepta hydrate, zinc phosphate, manganese sulphate, borax, sodium tetraborate, boric acid, di-sodium tetraborate penta hydrate, copper sulphate, ferrous sulphate, magnesium sulphate, magnesium hydroxide, ammonium molybdate, and chelated zinc.
   9. The composition according to paragraph 2, wherein the liquid fertilizers is combinations of macro nutrients such as salts and/or ions of Nitrogen, Phosphorous, Potassium and micro-nutrients such as sulphur, calcium, magnesium, boron, zinc, iron, manganese, copper, molybdenum, chlorine, selenium.
   10. The composition according to paragraph 2, wherein LCO is represented by a structure:

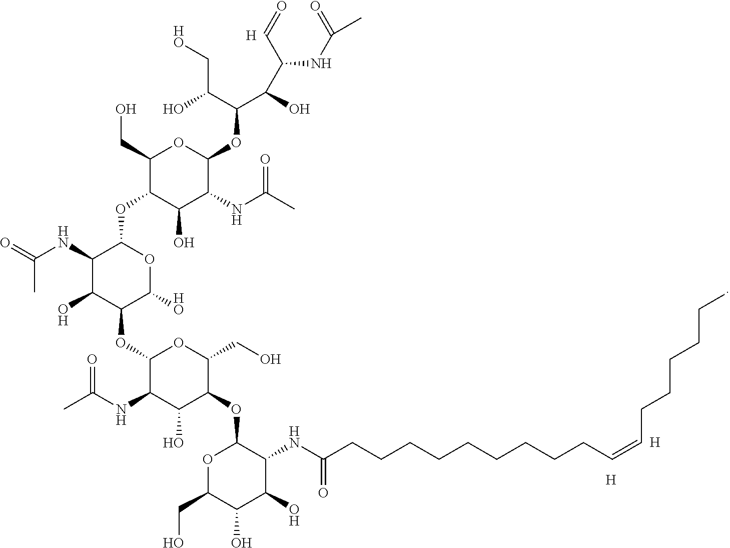

11. The composition according to paragraph 2, wherein the one or more preservatives is selected from a group consisting of sodium benzoate, calcium sorbate, and dipropylene glycol solution of 1,2-benzisothiazolin-3.
12. The composition according to any preceding paragraphs, wherein the composition further comprises a coating agent.
13. The composition according to paragraph 12, wherein the coating agent is an anticaking agent.
14. The composition according to paragraph 13, wherein the anticaking agent is selected from a group consisting of tricalcium phosphate, powdered cellulose, magnesium stearate, sodium bicarbonate, sodium ferrocyanide, potassium ferrocyanide, calcium ferrocyanide, calcium phosphate, sodium silicate, silicon dioxide, calcium silicate, magnesium trisilicate, talcum powder, sodium aluminosilicate, potassium aluminium silicate, calcium aluminosilicate, bentonite, aluminium silicate, stearic acid, polydimethylsiloxane, and slack wax and/or mineral oil along with fatty amines of varied hydrocarbon chain length.
15. The composition according to paragraphs 13-14, wherein the composition comprises at least 0.5-4 kg of anticaking agent per ton of water-soluble fertilizers.
16. The composition according to paragraph 15, wherein the composition comprises at least 2 kg of anticaking agent per ton of water-soluble fertilizers.
17. The composition according to any of preceding paragraphs, wherein the composition further comprises one or more urease inhibitors.
18. The composition according to paragraph 17, wherein the urease inhibitor is N-(n-butyl) thiophosphoric triamide (NBPT) and/or N-(n-propyl) thiophosphoric triamide (NPPT).
19. The composition according to paragraph 17, wherein the composition comprises 400-800 parts per million (ppm) of urease inhibitor per ton of fertilizers.
20. The composition according to paragraph 19, wherein the composition comprises 600 ppm of urease inhibitors and 1-2 kilograms pH stabilizer per ton of fertilizers.
21. The composition according to paragraph 20, wherein the pH stabilizer is magnesium 21 oxide.
22. The composition according to any of preceding paragraphs, wherein the composition further comprises one or more biologicals.
23. The composition according to paragraph 22, wherein the one or more biologicals are selected from a group consisting of:
i. microbes having nutrient solubilizing and nutrient mobilizing functions;
ii. fungi, bacteria or actinomycetes that belong to class-1 and elicit function of nutrient solubilization;
iii. free living nitrogen fixing bacteria; and
iv. Phosphorous mobilizing microbes; and
v. organisms or microbes for control of pests and diseases of crop plants.
   24. The composition according to any of preceding paragraphs, wherein the composition further comprises one or more bio-stimulants.
   25. The composition according to paragraph 24, wherein the one or more bio-stimulants are selected from a group consisting of humates and humic acids, fulvic acids, lignin, seaweeds and seaweed extracts and other plant and microbial extracts that promote plant growth and development, synthetic, natural or nature identical plant growth regulating substances or plant immunity triggering or enhancing substances, plant protection substances and biocides.
   26. The composition according to paragraph 25, wherein the synthetic, natural or nature identical plant growth regulating substances is selected from a group consisting of auxins, gibberellins, cytokinins, abscisic acids, ethylene, brassinosteroids, and plant immunity response triggering compounds.
   27. The composition according to paragraph 26, wherein the plant immunity response triggering compounds is selected from a group consisting of jasmonic acids, salicylic acids, phenols, chitins, microbial toxins, chemical ligands, and drugs.
   28. The composition according to any of preceding paragraphs, wherein the composition comprises 0.050-0.150 parts per billion (ppb) of LCO in water-soluble fertilizers.
   29. The composition according to any of preceding paragraphs, wherein the composition comprises 0.030-0.10 parts per billion (ppb) of LCO in granular fertilizers.
   30. The composition according to any of preceding paragraphs, wherein the composition comprises 7.6-11.4 ppb of LCO in 1.0 litre per acre of liquid fertilizers.
   31. A method of fortifying fertilizers with LCOs, the method comprising mixing one or more fertilizers with LCOs and one or more agents selected from a group consisting of one or more coating agents, one or more urease inhibitors, one or more biologicals and/or one or more bio-stimulants.
   32. The method according to paragraph 31, the method comprising:
a. mixing LCO with the one or more agents; and
b. spraying or mixing the one or more agents with LCOs on the one or more fertilizers.
   33. A method according to paragraph 31, wherein the one or more fertilizers is water-soluble fertilizers, granular fertilizers, or liquid fertilizers.
   34. The method according to paragraph 33, wherein water-soluble fertilizers is selected from a group comprising of: urea, nitrogen:phosphorous:potassium (NPK), micronutrients, calcium nitrate, nitrogen:phosphorous:potassium:sulphur:calcium:boron (NPKSCaB), urea phosphate, potassium nitrate, Mono potassium phosphate, sulphate of potash, mono ammonium phosphate, urea sulphate of potash and sulphur, sulphate of potash with sulphur, and NPKSB.
   35. The method according to paragraph 34, wherein the micronutrients in water-soluble fertilizers is selected from a group consisting of: boron, zinc sulphate, sulphur bentonite, magnesium sulphate, chelated forms of iron, chelated forms of zinc, chelated forms of magnesium, and chelated forms of calcium.
   36. The method according to paragraph 33, wherein the granular fertilizer is selected from a group consisting of:
a. one or more complex fertilizers;
b. one or more straight fertilizers; and
c. one or more micronutrients.
   37. The method according to paragraph 36, wherein the one or more complex fertilizers is from a group consisting of nitrogen:phosphorous:potassium (NPK), selected nitrogen:phosphorous:potassium:sulphur (NPKS+S), nitrogen:phosphorous:potassium:magnesium (NPK+Mg), nitrophosphate with potash, diammonium phosphate (DAP) granules, ammonium phosphate sulphate, ammonium phosphate sulphate nitrate, nitrophosphate, urea ammonium phosphate, mono ammonium phosphate, ammonium nitrate phosphate and ammonium phosphate.
   38. The method according to paragraph 36, wherein the one or more straight fertilizers is selected from a group consisting of urea granules, urea super granules, urea briquettes, ammonium sulphate granules, calcium ammonium nitrate granules, ammonium chloride granules, single super phosphate granules, rock phosphate granules, murate of potash (KCl) granules, potassium sulphate granules, potassium magnesium sulphate granules and granulated sulphur.
   39. The method according to paragraph 36, wherein the one or more micronutrients in the granular fertilizers is selected from a group consisting of zinc sulphate hepta hydrate, zinc phosphate, manganese sulphate, borax, sodium tetraborate, boric acid, di-sodium tetraborate penta hydrate, copper sulphate, ferrous sulphate, magnesium sulphate, magnesium hydroxide, ammonium molybdate, and chelated zinc.
   40. The method according to paragraph 33, wherein the liquid fertilizers is combinations of macro nutrients such as salts and/or ions of Nitrogen, Phosphorous, Potassium and micro-nutrients such as sulphur, calcium, magnesium, boron, zinc, iron, manganese, copper, molybdenum, chlorine, selenium.
   41. The method according to paragraph 31, wherein LCO is represented by a structure:

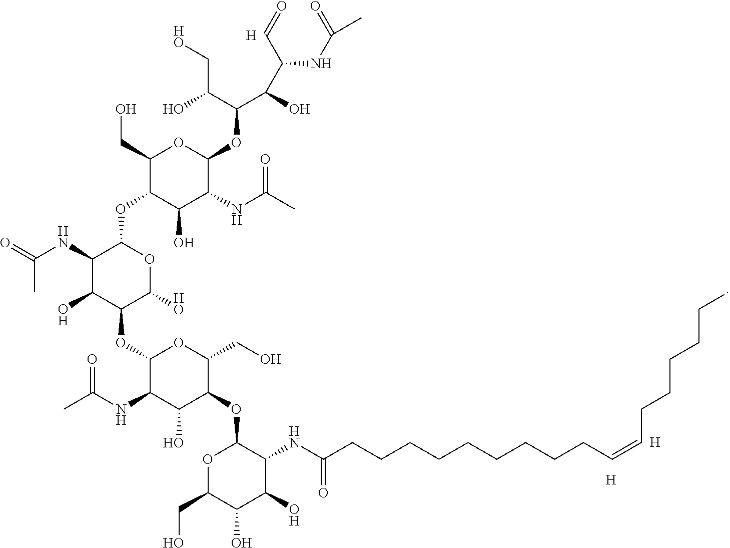

42. The method according to paragraph 31, wherein the coating agent is an anticaking agent.
43. The method according to paragraph 42, wherein the anticaking agent is selected from a group consisting of tricalcium phosphate, powdered cellulose, magnesium stearate, sodium bicarbonate, sodium ferrocyanide, potassium ferrocyanide, calcium ferrocyanide, calcium phosphate, sodium silicate, silicon dioxide, calcium silicate, magnesium trisilicate, talcum powder, sodium aluminosilicate, potassium aluminium silicate, calcium aluminosilicate, bentonite, aluminium silicate, stearic acid, and polydimethylsiloxane, slack wax and/or mineral oil along with fatty amines of varied hydrocarbon chain length.
44. The method according to paragraphs 42-43, wherein the LCO fortified fertilizer comprises at least 0.5-4 kg of anticaking agent per ton of water-soluble fertilizers.
45. The method according to paragraph 44, wherein the LCO fortified fertilizer comprises at least 2 kg of anticaking agent per ton of water-soluble fertilizers.
46. A method according to paragraph 31, the method comprising:
a. mixing LCO with one or more urease inhibitors; and
b. spraying the one or more urease inhibitors with LCOs on the one or more fertilizers.
   47. The method according to paragraph 31, wherein the urease inhibitor is N-(n-butyl) thiophosphoric triamide (NBPT) and/or N-(n-propyl) thiophosphoric triamide (NPPT).
   48. The method according to paragraphs 46-47, wherein the method comprises spraying 400-800 parts per million (ppm) of urease inhibitor per ton of fertilizer.
   49. The method according to paragraphs 46-48, wherein the method comprises spraying 600 parts per million (ppm) of urease inhibitor per ton of fertilizer.
   50. The method according to paragraphs 46-49, wherein the method further comprises adding pH stabilizer per ton of fertilizer.
   51. The method according to paragraph 50, wherein the method comprises adding 1-2 kilograms pH stabilizer per ton of fertilizer.
   52. The method according to paragraph 50, wherein the pH stabilizer is magnesium oxide.
   53. The method according to paragraph 31, wherein the biologicals are selected from a group consisting of:
i. microbes having nutrient solubilizing and nutrient mobilizing functions;
ii. fungi, bacteria or actinomycetes that belong to class-1 and elicit function of nutrient solubilization;
iii. free living nitrogen fixing bacteria;
iv. phosphorous mobilizing microbes; and
V. organisms or microbes for control of pests and diseases of crop plants.
   54. The method according to paragraph 31, wherein the one or more bio-stimulants are selected from a group consisting of humates and humic acids, fulvic acids, lignin, seaweeds and seaweed extracts and other plant and microbial extracts that promote plant growth and development, synthetic, natural or nature identical plant growth regulating substances or plant immunity triggering or enhancing substances, plant protection substances and biocides.
   55. The method according to paragraph 54, wherein the synthetic, natural or nature identical plant growth regulating substances is selected from a group consisting of auxins, gibberellins, cytokinins, abscisic acids, ethylene, brassinosteroids, and plant immunity response triggering compounds.
   56. The method according to paragraph 55, wherein the plant immunity response triggering compounds is selected from a group consisting of jasmonic acids, salicylic acids, phenols, chitins, microbial toxins, chemical ligands, and drugs.
   57. The method according to paragraphs 31-55, the method further comprising adding one or more preservatives to the fertilizers
   58. The method according to paragraph 57, wherein the one or more preservatives is selected from a group consisting of sodium benzoate, calcium sorbate, and dipropylene glycol solution of 1,2-benzisothiazolin-3.
   59. The method according to paragraphs 33-58, wherein the LCO fortified fertilizer comprises 0.050-0.150 parts per billion (ppb) of LCO in water-soluble fertilizers.
   60. The method according to paragraphs 33-58, wherein the LCO fortified fertilizer comprises 0.030-0.10 parts per billion (ppb) of LCO in granular fertilizers.
   61. The method according to paragraphs 33-58, wherein the LCO fortified fertilizer comprises 7.6-11.4 ppb of LCO in 1.0 litre per acre of liquid fertilizers.
   62. Use of the composition paragraphed in 1-26 to enhance plant growth and/or yield.
   63. The use according to paragraph 62, wherein the plant growth and/or yield comprises increased root branching, increased root hairs, enhanced nutrient use efficiency, enhanced symbiotic activity, enhanced population of PGPRs, early flowering, profuse flowering, increase in fruit and/or seed sizes and numbers.
   64. The method for enhancing plant growth and/or yield, wherein the method comprises applying an effective amount of the composition according to paragraphs 1-26 to plant, plant part, plant seed, and/or soil.

### EXAMPLES

The following examples are not intended to be a detailed catalogue of all the diverse ways in which the present disclosure may be implemented or of all the features that may be added to the present disclosure. Subjects skilled in the art will appreciate that numerous variations and additions to the various embodiments may be made without departing from the present disclosure. Hence, the following descriptions are intended to illustrate some particular embodiments of the invention and not to exhaustively specify all permutations, combinations, and variations thereof.

Unless otherwise indicated, the percentages set forth in the following examples are by weight, based upon the total weight of the composition.

### Material and Methods

### Example 1—Effect of Water-Soluble Fertilizer Fortified with LCOs on Cabbage Yield

Cabbage seedling (Enza zaden variety) were transplanted on 16 Oct. 2020 and the experiment was completed by end of December 2020. Experiment was conducted in 3*3 microplots in 9 replications for treatment and control, microplots were distributed in a completed random block experimental design. Treatment was imposed by fertigation at 3 times point with doses divided in to 22, 39 and 39% respectively (Table 6). Plants were grown by following the standard package of practices developed by the university of Agricultural Science Bangalore.

TABLE 6
Treatment Details

| | | | | | | | | | | Application rate, | | |
|---|---|---|---|---|---|---|---|---|---|---|---|---|
| | | | | | | | | | | time and dosage | | |
| | | | | | | | | | | recommended per | | |
| | | | | | | | | Basal dose | | plot in g (LCO + WSF) | | |
| | LCO dose | | | | | | | NPK | | 1st | 2nd | 3rd |
| | optimisation | | | | | | | application | | dose | dose | dose |
| | with | | LCO | | LCO | LCO | LCO | (g/plot) | | (0 | (20 | (40 |
| T | WSF | | ml/kg | WSF | (ml/ | (ml/ | (ml/ | GF | | DAS) | DAS) | DAS) |
| No | (Cabbage) | LCO | fertilizer | 19:19:19 | acre) | plot) | dose) | 19All | Urea | 22% | 39% | 39% |
| 1 | Control | | 0 | 200 | No | 0 | 0 | 158 g | 49 g | 100 g | 175 g | 175 g |
| | (only | | | Kg/Acre | | | | | | | | |
| | WSF) | | | | | | | | | | | |
| 2 | Low LCO | With | 0.3 | | 60 | 0.135 | 0.045 | | | | | |
| 3 | Medium | proxel | 0.6 | | 120 | 0.27 | 0.09 | | | | | |
| | LCO | | | | | | | | | | | |
| 4 | High LCO | | 0.9 | | 180 | 0.405 | 0.135 | | | | | |
| 5 | Low LCO | Without | 0.3 | | 60 | 0.135 | 0.045 | | | | | |
| 6 | Medium | proxel | 0.6 | | 120 | 0.27 | 0.09 | | | | | |
| | LCO | | | | | | | | | | | |
| 7 | High LCO | | 0.9 | | 180 | 0.405 | 0.135 | | | | | |

Treatment was in a complete random block design, with 9 replications per treatment. Following parameter/observation was recorded:
1. Plant number per plot
2. Fruit weight per plot
3. Fruit weight per plant
4. Vertical circumference
5. Radial circumference

### Data Analysis Microplot:

Data were analysed with JMP software by comparing means using all pairs Tukey HSD. Error bars shown in graphs are SD. Bar graphs represent the mean. Different alphabet indicates significant difference between the treatment.

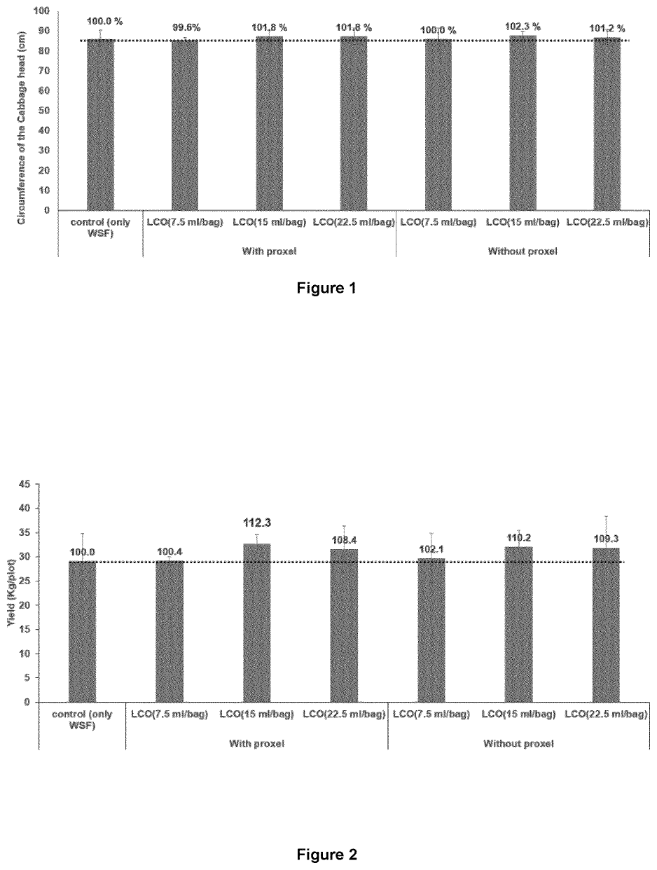

FIG. 1: Cabbage circumference was determined after measuring the radial and vertical circumference of each cabbage. Error bar represents standard deviation. NS indicates no significant difference between the treatment.

Cabbage circumferences were determined at the end of harvest by measuring the vertical circumference and radial circumference. None of the treatment differed significantly compared to control but increasing trend was observed. Average of 2% increase in circumference observed when treated with LCO with or without proxel. Among the doses, medium LCO seems promising (FIG. 1).

Treatment influenced increasing the cabbage yield. FIG. 2: Cabbage yield were determined at the end of harvest. Error bar represents standard deviation. NS indicates no significant difference between the treatment.

None of the treatment differed significantly compared to control but increasing trend observed for yield (kg/plot). Average of 7% increase in yield observed when treated with LCO with or without proxel. Up to 12% yield gain was observed when WSF was fortified with 15 ml of LCO per bag (FIG. 2). LCO fortification with water-soluble fertilizer increases the profit to the farmers.

### Conclusion:

1. Addition of LCO with WSF has a yield advantage compared to WSF alone respectively,
2. LCO without Proxel provided marginally better yields over LCO with Proxel
3. LCO fortification with WSF resulted in 12% increase in yield.
4. Bio-efficacy of LCO is higher when fortified with WSF due to multiple applications through fertigation. Plants get intermittent supply of LCO throughout the lifecycle.
5. Increased yield is due to the increased head circumference.
6. LCO fortification improves yield and profit for the farmers contributing to doubling of farm income.

### Example 2—Effect of Water-Soluble Fertilizer Fortified with LCOs on Capsicum Yield

Capsicum seedling (Diana variety) were transplanted on 16 Jul. 2021 and the experiment was completed by end of October 2022 in the net house. Experiment was conducted in paired row pots (24 Sq M) with 4 replications for treatment and control, plots were distributed in a completed random block experimental design. Treatment was imposed by fertigation at 3 times point with doses divided in to 22, 39 and 39% respectively (Table 7). Plants were grown by following the standard package of practices developed by the university of Agricultural Science Bangalore.

TABLE 7
Treatment Details

| | | | | | | | | | | Application rate, | | |
|---|---|---|---|---|---|---|---|---|---|---|---|---|
| | | | | | | | | | | time and dosage | | |
| | | | | | | | | | | recommended | | |
| | | | | | | | | Basal dose NPK | | per plot in g | | |
| | LCO | | | | | | | application | | (LCO + WSF) | | |
| | dose | | | | | | | by granular | | 1st | 2nd | 3rd |
| | optimization | | | | | | | fertilizers | | dose | dose | dose |
| | with | | LCO | | LCO | LCO | LCO | (g/plot) | | (0 | (30 | (60 |
| T | WSF | | ml/kg | WSF | (ml/ | (ml/ | (ml/ | | GF | DAS) | DAS) | DAS) |
| No | (Capsicum) | LCO | fertiliser | 19:19:19 | acre) | plot) | dose) | Urea | 19All | 22% | 39% | 39% |
| 1 | control | No | 0 | 100 | No | 0.00 | 0.00 | 146 g | 130 g | 50 g | 88 g | 88 g |
| | (only | | | Kg/Acre | | | | | | | | |
| | WSF) | | | | | | | | | | | |
| 2 | Low LCO | With | 0.3 | | 30 | 0.068 | 0.0226 | | | | | |
| 3 | Medium | proxel | 0.6 | | 60 | 0.136 | 0.0452 | | | | | |
| | LCO | | | | | | | | | | | |
| 4 | High LCO | | 0.9 | | 90 | 0.203 | 0.0678 | | | | | |
| 5 | Low LCO | Without | 0.3 | | 30 | 0.068 | 0.0226 | | | | | |
| 6 | Medium | proxel | 0.6 | | 60 | 0.136 | 0.0452 | | | | | |
| | LCO | | | | | | | | | | | |
| 7 | High LCO | | 0.9 | | 90 | 0.20 | 0.0678 | | | | | |

Treatment was in a complete random block design, with 9 replications per treatment. Following parameter/observation was recorded:
1. Fruit weight per plot
2. Fruit weight per plant

### Data Analysis Microplot:

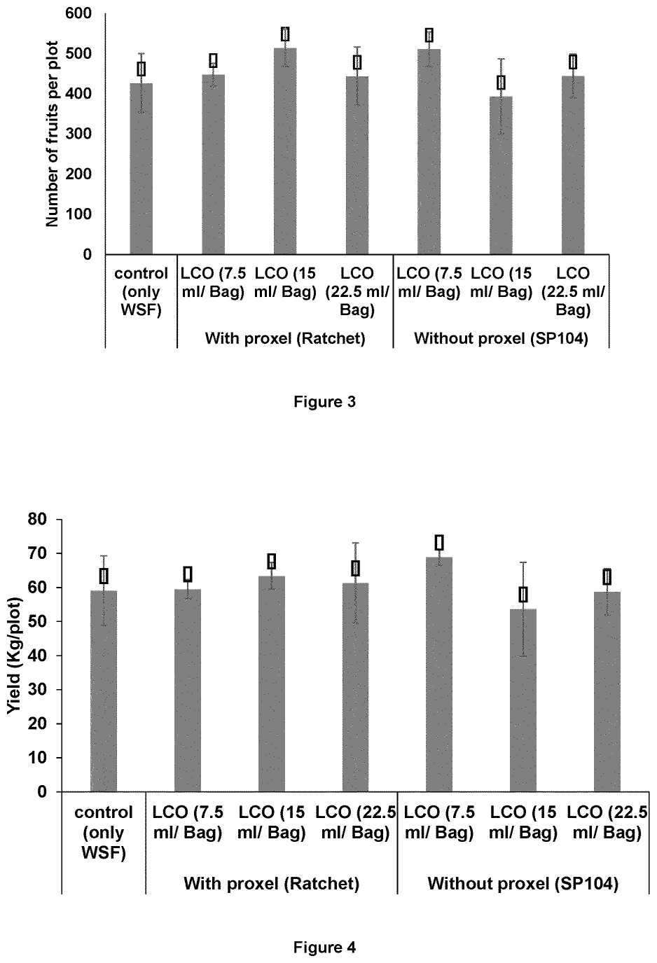

Data was analysed with JMP software by comparing means using all pairs Tukey HSD. Error bars shown in graphs are SD. Bar graphs represent the mean. Different alphabet indicates significant difference between the treatment. Fortification of WSF with LCO resulted in increase in yield. FIGS. 3 & 4: Fruit number and yield per plot were determined at each harvest, data represent the sum of the fruit number and yield harvested during the cropping season. Error bar represents standard deviation. NS indicates no significant difference between the treatment.

Fortification of WSF with LCO resulted in increase in yield, even though there is no statistically significant difference. 7% increase in yield observed when WSF was fortified with 15 ml of LCO (ratchet) per bag of fertilizer and 17% increase in yield observed when WSF was fortified with 7.5 ml of LCO (SP104).

### Conclusion:

1. Fortification of WSF with LCO (Ratchet) at 15 ml per bag of WSF resulted in 7% yield advantage over control.
2 Fortification of WSF with LCO (SP104) at 7.5 ml per bag of WSF resulted in 17% yield advantage over control.

### Example 3—Bio Efficacy of the Water-Soluble Fertilizer (19:19:19) Fortified with LCO Through Seedling Bioassay in Tubes

TABLE 8
Treatment details:

| | | | Concentration | | | |
|---|---|---|---|---|---|---|
| S. No | Treatment | | (percentage %) | Crop | Replications | Phenotyping |
| 1 | C | Control | | White | 20 | Hypocotyl length, |
| 2 | T2 | LCO dose 1 | 8.75E−12 | French | | Epicotyl length, |
| 3 | T3 | LCO dose 2 | 8.75E−14 | Beans | | Shoot length and |
| 4 | T4 | WSF dose 1 | 8.75E−12 | | | Root length |
| 5 | T5 | WSF dose 2 | 8.75E−14 | | | |
| 6 | T6 | WSF + LCO | 8.75E−12 | | | |
| | | dose 1 | | | | |
| 7 | T7 | WSF + LCO | 8.75E−14 | | | |
| | | dose 2 | | | | |

### Methodology:

Locally available beans variety were used for the study. Experiment was conducted in 50 ml falcon tube filled with soilrite which acts as growing substrate. Treatment solution as given in the table were prepared in demineralised water and 10 ml of respective solution were applied to each tube after sowing (2.5 cm depth). Fortified, unfortified WSF and LCO were tested at 2 doses along with absolute control. Subsequently, the seedlings were maintained under constant light (200 micro moles/cm2, 12 hrs light and dark), ambient temperature of 25 degree Celsius. The tubes were incubated for 10 days and irrigated with water as and when required. After 10 days, the experiment was terminated and the plants were phenotyped for recording the traits vz Hypocotyl length, epicotyl length, shoot length and root length.

### Results:

The results exhibited that the performance of WSF when used alone and when fortified with LCO, on seedling growth, in comparison to untreated control. LCO clearly increases the efficacy and potency of WSFs.

FIG. 1: Epicotyl length and shoot length were measured from 10-day old beans seedling, n=20. Error bar represents standard deviation. There was no statistically significant difference between the treatment compared to control.

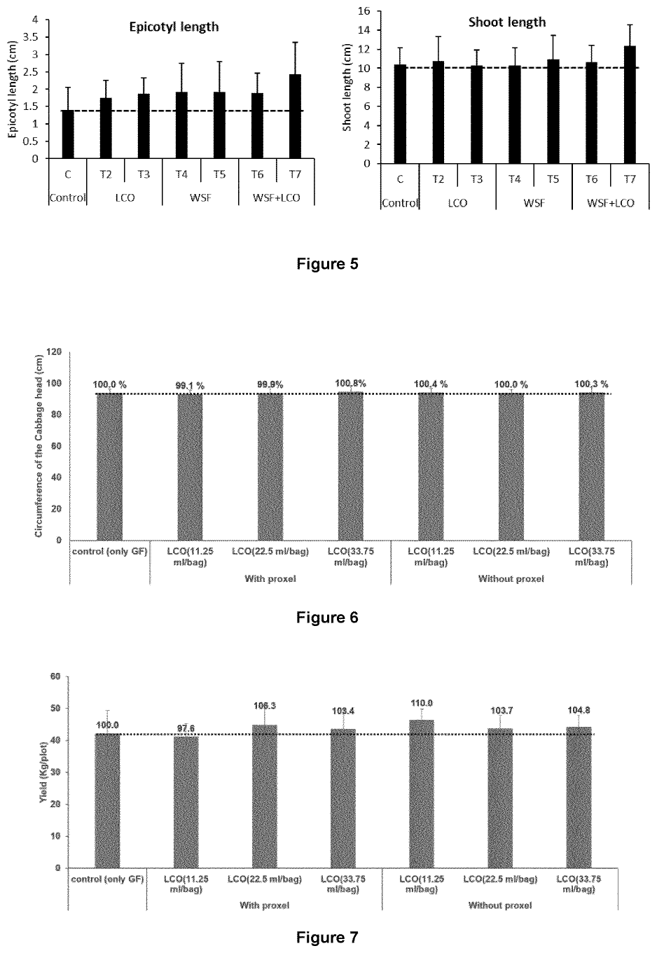

Beans seedling were phenotyped at the end of 10 days for the hypocotyl length, epicotyl length and root length. 18% increased shoot growth was observed in the fortified WSF compared to absolute control and 12% increase in shoot growth when compared to WSF alone (FIG. 5). 3% increased root growth was observed in the fortified WSF compared to absolute control, and the phenotyped parameter which are more than the control are highlighted in bold in Table 9.

TABLE 9

| | Assay | | | | | | | | |
|---|---|---|---|---|---|---|---|---|---|
| | (seedling | | | LCO (%) | | WSF (%) | | WSF + LCO (%) | |
| Crop | tube) | Parameter (cm) | Control | 8.75E−12 | 8.75E−14 | 8.75E−12 | 8.75E−14 | 8.75E−12 | 8.75E−14 |
| Beans | Seedling | Hypocotyl length | 8.9 | 9 | 8.3 | 8.3 | 9 | 8.7 | 9.9 |
| | assay | Epicotyl length | 1.4 | 1.75 | 1.87 | 1.92 | 1.92 | 1.89 | 2.42 |
| | | Shoot length* | 10.38 | 10.77 | 10.26 | 10.25 | 10.94 | 10.62 | 12.33 |
| | | Root length | 12.48 | 12.12 | 13.41 | 13.27 | 13.77 | 12.65 | 12.89 |

*Shoot length = hypocotyl + Epicotyl length

### Conclusion:

1. Increased shoot growth observed in LCO fortified WSF over and above WSF alone.
2. LCO fortification leads to early vigor, and better growth rates.

### Example 4—Effect of Granular Fertilizer Fortified with LCOs on Cabbage Yield

Cabbage seedling (Enza zaden variety) were transplanted on 16 Oct. 2020 and the experiment was completed by first week of January 2021. Experiment was conducted in 3*3 microplots in 7 replications for treatment and 6 replications for control, microplots were distributed in a completed random block experimental design. Treatment was imposed by fertigation at 2 times point with doses divided in to 50% each first at time of transplanting and second one at 40 days after transplanting (Table 1 & 2). Plants were grown by following the standard package of practices developed by the university of Agricultural Science Bangalore, for further details information have a look at the crop calendar (Table 10).

TABLE 10
Treatment details

| | | | | | | Basal dose NPK | | Application rate, |
|---|---|---|---|---|---|---|---|---|
| | | | | | | application | | time and dosage |
| | | | | | | by granular | | recommended |
| | | | | | | fertilizers | | per plot in g |
| | LCO dose | | LCO | | | (g/plot)50% | | (LCO + GF) |
| T | optimization | | ml/kg | GF | LCO | | GF 19All | Full dose (40 |
| No | with GF | LCO | fertilizer | 19:19:19 | (ml/acre) | Urea | (50%) | DAS) 50% |
| 1 | control (only | | 0 | 270 | 0 | 45 g | 304 g | 304 g |
| | GF) | | | Kg/Acre | | | | |
| 2 | Low LCO | With | 0.225 | | 60.75 | | | |
| 3 | Medium LCO | proxel | 0.45 | | 121.5 | | | |
| 4 | High LCO | | 0.675 | | 182.25 | | | |
| 5 | Low LCO | Without | 0.225 | | 60.75 | | | |
| 6 | Medium LCO | proxel | 0.45 | | 121.5 | | | |
| 7 | High LCO | | 0.675 | | 182.25 | | | |

Treatment was in a complete random block design, with 7 replications per treatment and 6 replication per control. Following parameter/observation was recorded:
1. Plant number per plot
2. Fruit weight per plot
3. Fruit weight per plant
4. Vertical circumference
5. Radial circumference

### Data Analysis Microplot:

Data were analysed with JMP software by comparing means using all pairs Tukey HSD. Error bars shown in graphs are SD. Bar graphs represent the mean. Different alphabet indicates significant difference between the treatment. Treatments with LCO resulted in marginal increase in circumference of cabbage heads. FIG. 6: Cabbage circumference was determined after measuring the radial and vertical circumference of each cabbage. Error bar represents standard deviation. NS indicates no significant difference between the treatment.

Cabbage circumferences were determined at the end of harvest by measuring the vertical circumference and radial circumference. None of the treatment differed significantly compared to control but marginal increasing trend was observed. Average of 0.4% increase in circumference observed when treated with LCO with or without proxel (FIG. 6). Treatment influenced increasing the cabbage yield. FIG. 7: Cabbage yield were determined at the end of harvest. Error bar represents standard deviation. NS indicates no significant difference between the treatment.

None of the treatment differed significantly compared to control but increasing trend observed for yield (kg/plot). 6% increase in yield observed when treated with medium LCO with proxel. 10% increase in yield observed when treated with low LCO without proxel, up to 10% yield gain was observed when BGF was fortified with 11.25 ml of LCO per bag (FIG. 7).

### Conclusion:

1. Addition of LCO with BGF has a yield advantage compared to BGF alone respectively.
2. LCO without Proxel provided marginally better yields over LCO with Proxel
3. LCO fortification with BGF resulted in 10% increase in yield.
4. LCO fortification improves yield and profit for the farmers contributing to doubling of farm income.

### Example 5—Effect of Granular Fertilizer Fortified with LCOs on Corn Yield

Maize seeds were sown directly to microplot on 29 Oct. 2020 and the experiment was completed by third week of January 2021. Experiment was conducted in 3*3 microplots in 7 replications for treatment and 6 replications for control, microplots were distributed in a completed random block experimental design. Treatment was imposed by fertigation at 2 times point with doses divided in to 50% each first at time of transplanting and second one at 40 days after transplanting (Table 11). Plants were grown by following the standard package of practices developed by the university of Agricultural Science Bangalore, for further details information have a look at the crop calendar (Table 11).

TABLE 11
Treatment details

| | | | | | | Basal dose NPK | | Application rate, |
|---|---|---|---|---|---|---|---|---|
| | | | | | | application by | | time and dosage |
| | | | | | | granular | | recommended |
| | | | | | | fertilizers | | per plot in g |
| | LCO dose | | LCO | | | (g/plot)50% | | (LCO + GF) |
| T | optimization | | ml/kg | GF | LCO | 19 All GF | | Full dose (40 |
| No | with GF | LCO | fertilizer | 19:19:19 | (ml/acre) | (50%) | UREA | DAS) 50% |
| 1 | control | | 0 | 158 | No | 178 g | 146 g | 178 g |
| | (only WSF) | | | Kg/Acre | | | | |
| 2 | Low LCO | With | 0.225 | | 35.55 | | | |
| 3 | Medium | proxel | 0.45 | | 71.1 | | | |
| | LCO | | | | | | | |
| 4 | High LCO | | 0.675 | | 106.65 | | | |
| 5 | Low LCO | Without | 0.225 | | 35.55 | | | |
| 6 | Medium | proxel | 0.45 | | 71.1 | | | |
| | LCO | | | | | | | |
| 7 | High LCO | | 0.675 | | 106.65 | | | |

Treatment was in a complete random block design, with 7 replications per treatment and 6 replication per control. Following parameter/observation WAS recorded:
1. Plant number per plot
2. Plant height
3. Chlorophyll content
4. Stem girth
5. Cob number
6. Cob dry weight
7. Yield/grain weight per plot or plant

### Data Analysis Microplot:

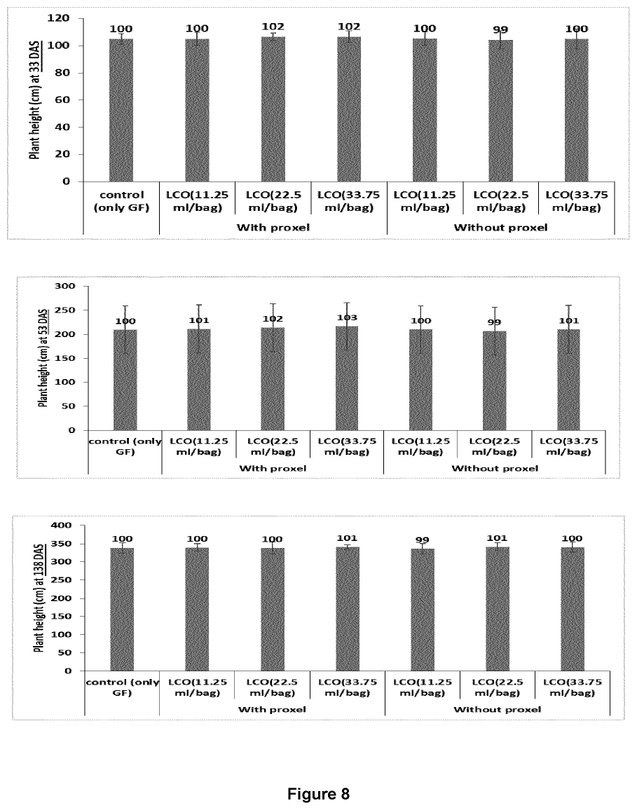

Data were analysed with JMP software by comparing means using all pairs Tukey HSD. Error bars shown in graphs are SD. Bar graphs represent the mean. Different alphabet indicates significant difference between the treatment. Plant height did not differ significantly compared to control. FIG. 8: Plant height were measured at three different time point viz 33, 53 and 138 days after sowing, data represented here are means and error bar represent standard deviation. NS denotes no significant difference between the treatment.

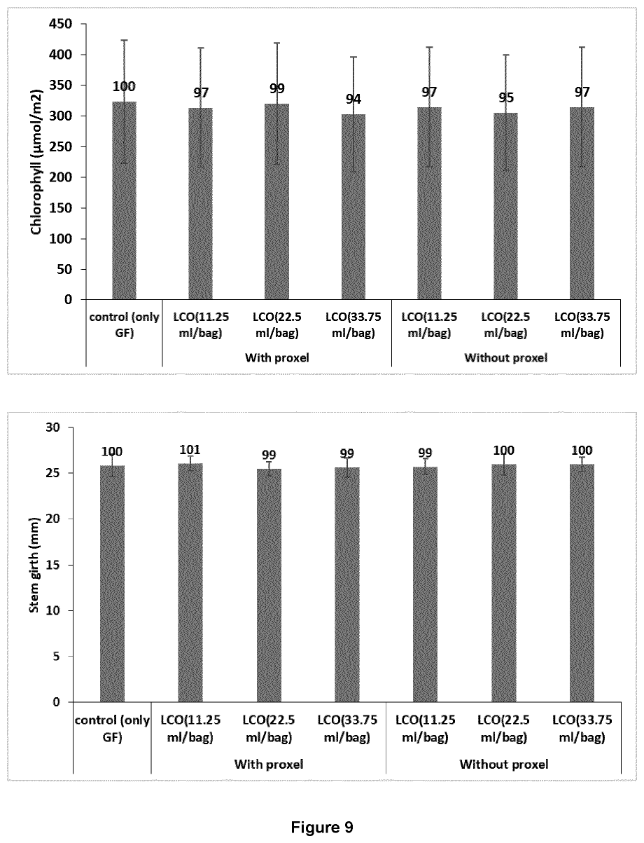

Treatment did not have a significant effect on altering the plant height measured at three different time point (FIG. 8), plant reached a maximum height of more than 3.6 meters in length. Unlike plant height, treatment did not have any effect on altering the chlorophyll content (FIG. 9). Stem girth which was measured at the base about 2 cm above the sol did not differ significantly (FIG. 9).

Chlorophyll and stem girth did not differ significantly compared to control. FIG. 9: Chlorophyll content were determined at 33 days after sowing and the stem girth were determined using vernier caliper leaving 2 cm from the soil surface data represented here are means and error bar represent standard deviation. NS denotes no significant difference between the treatment.

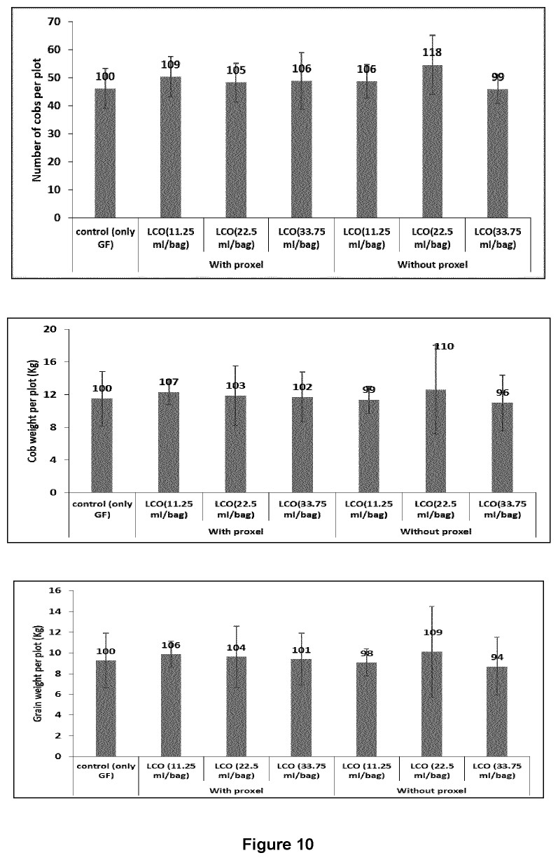

None of the treatment differed significantly compared to control but increasing trend observed for number of cobs per plant with a maximum of 18% increase. Increasing trend were also observed for cob weight per plot and grain weight per plot with a maximum increase of 10 and 9 respectively (FIG. 10). These increasing trend over control were observed when LCO were used at the rate of 22.5 ml per bag.

Treatment has a positive effect on increasing the yield traits. FIG. 10: Yield related traits in maize viz cob number, cob dry weight and grain weight were determined at the end of the experiment. Data represented here are means and error bar represent standard deviation. NS denotes no significant difference between the treatment.

### Example 6: Effect of LCO and Urease Inhibitor Fortified Fertilizer on Plant Height, Chlorophyll Content, Root Dry Weight, Dry Leaf Weight and Leaf Area Measurements

Fortification of LCO and Urease Inhibitor with Urea and Water-Soluble Fertilizers
Preparation of NBPT Doses for Fortifying with Fertilizers:

NBPT (N-(n-butyl) thiophosphoric triamide) was suspended in propylene glycol (PG) and dimethyl sulphoxide (DMSO) in the ratio of 20:50:30. In the current experiment two different doses of NBPT was fortified to the fertilizers, low dose consisting of 400 ppm and high dose 800 ppm was fortified per Kg of fertilizer.

Fortification of LCO and NBPT with WSF and Urea:

The fortifying mixture consists of 0.7 ml of LCO (1.90e-5) and 2 ml of NBPT (400 ppm) was fortified to 1 Kg of fertilizer. Whereas another fortifying mixture consists of 0.7 ml of LCO (1.90e-5) and 4 ml of NBPT (800 ppm) was fortified to 1 Kg of fertilizer. After fortification samples were taken for conducting pot trails.

### Evaluation of LCO and Urease Inhibitor Fortified Urea and WSF on Experimental Crops:

A pot study was conducted for evaluating LCO and Urease inhibitor fortified Urea and WSF on an experimental crop. Corn was selected as a subject crop for the pot study. The experiment consists of 13 treatments as listed below. The pot study is done in pots of 2 Kg soil capacity. The experiment duration is 20 days.

### Treatment Details for Pot Studies:

1. Untreated Control
2. WSF
3. WSF+LCO
4. WSF+LCO+UI (Low-400 ppm)
5. WSF+LCO+UI (High-800 ppm)
6. WSF+UI (Low-400 ppm)
7. WSF+UI (High-800 ppm)
8. UREA
9. UREA+LCO
10. UREA+LCO+UI (Low-400 ppm)
11. UREA+LCO+UI (High-800 ppm)
12. UREA+UI (Low-Low-400 ppm)
13. UREA+UI (High-800 ppm)

Seeds were sown in the pots at the same time fertilizers were applied as the basal dose. 800 mg of WSF was applied to the corn pot at the ratio of 100% of N, and 200% of P & K based on recommendation. For the urea study, 296 mg urea, 427 mg of SSP and 118 mg of MOP was applied to the corn pot at the ratio of 100% of recommended N P and K.

### Plant Phenotyping:

From the onset of the experiment plant height and chlorophyll was measured at every 10th, 15th, and 20th day after sowing. Plant height and dry biomass of leaves and root were measured manually using scales, whereas chlorophyll was measured using chlorophyll meter. Leaf area was calculated based on the dry weight method, by developing a dry-weight weight versus leaf area curve for corn leaf samples of known area.

### Estimation of Nitrogen (N) Content in Soil and Plant Samples

Available nitrogen from the soil was estimated from the soil samples using wet aggregate analysis method of estimation. (FAO of the United Nations, Rome, Chapter 3, Page 42:2008). The available nitrogen is expressed as kg/ha.

Total nitrogen as percent was determined from the dried plant samples using Kjeldahl method of estimation. The total nitrogen in plant is expressed as percentage. Nitrogen uptake was calculated by multiplying the shoot biomass with the nutrient concentration. Nitrogen use efficiency (NUE) is determined as the percent of the applied nitrogen that was taken up by the plants.

$$NUE ( \% ) = ( N uptake of the fertilized plant - N uptake of the unfertilized plant / Rate of N applied ) * 100.$$

From the onset of the experiment plant height and chlorophyll was measured every 5 days interval starting from 10th DAS. Plant height was measured manually, whereas chlorophyll was measured using chlorophyll meter. The root dry weight, dry leaf weight and leaf area were the end point measurements taken at the end of the experiment at 20 DAS.

### Results:

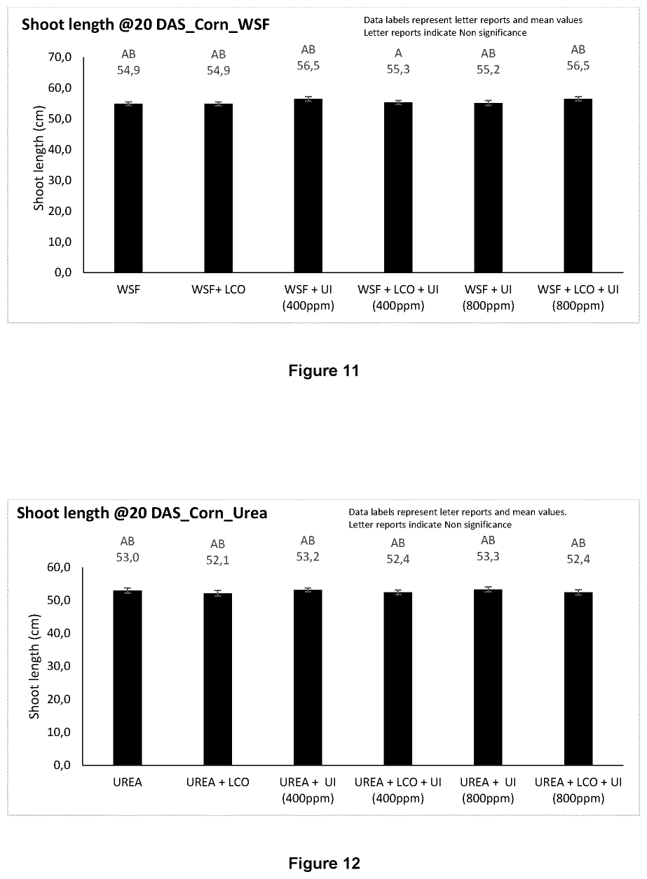

FIG. 11 shows:

1. The combination has a positive effect in enhancing shoot length over WSF alone.
2. Shoot length @ 20 DAS-WSF fortified with UI (800 ppm) and LCO is showing better shoot length over WSF alone and WSF+UI (800 ppm)

FIG. 12 shows that combining Urea+LCO+NBPT+UI resulted in similar performance for shoot length when compared to Urea+UI and Urea alone.

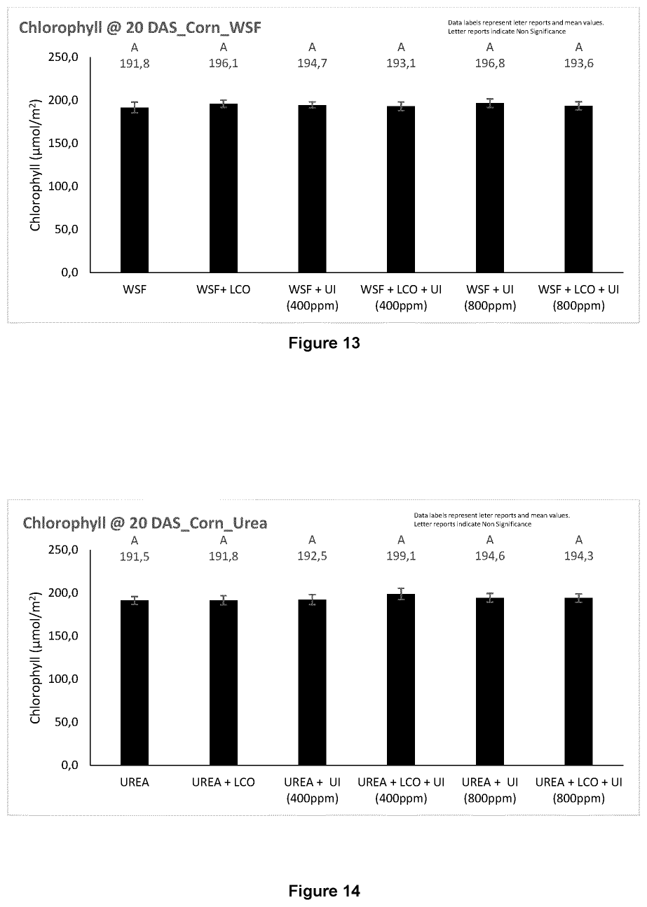

FIG. 13 shows that combining WSF+LCO+NBPT resulted in similar performance for Chlorophyll content when compared to WSF+UI and WSF alone.

FIG. 14 shows:

1. The combination has a positive effect in enhancing chlorophyll content over urea alone
2. Combining Urea+LCO+NBPT resulted in increased Chlorophyll content when compared to Urea+UI and Urea alone.

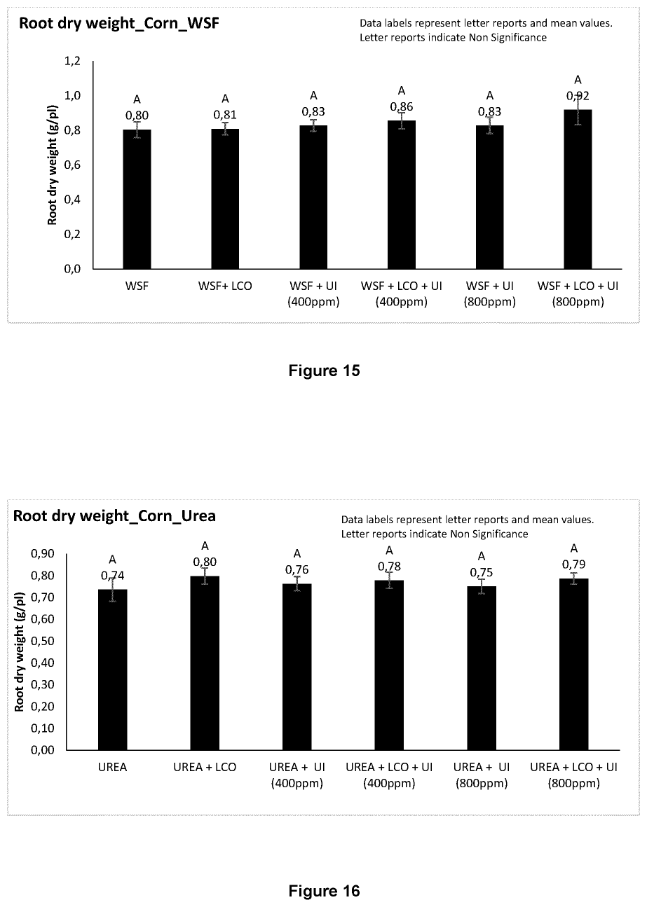

FIG. 15 shows:

1. The combination of WSF, LCO and UI is effective in enhancing root biomass in corn.
2. Combining WSF+LCO+NBPT resulted in increased average root dry weight compared to WSF+UI and WSF alone.

FIG. 16 shows:

1. The combination of Urea, LCO and UI is effective in enhancing root biomass in corn
2. Combining Urea+LCO+NBPT resulted similar performance for root dry weight when compared to Urea+UI and Urea alone.

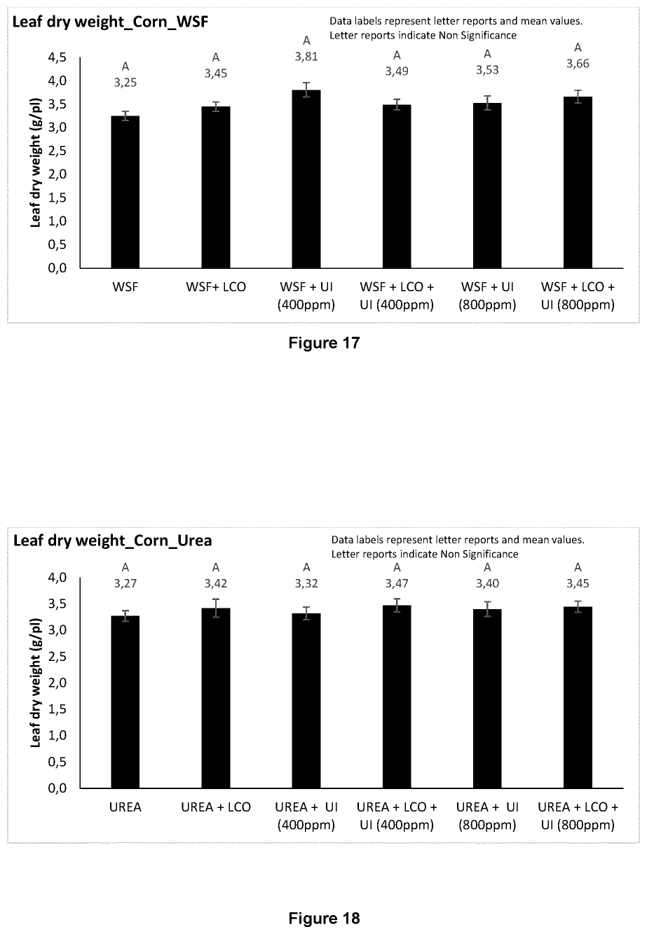

FIG. 17 shows:

1. The combination of WSF, LCO and UI is effective in enhancing leaf biomass in corn
2. Combination of WSF+LCO+NBPT is effective in increasing average leaf dry weight when compared to WSF+UI alone at both concentrations of 800 ppm of UI.

FIG. 18 shows:

1. The combination of Urea, LCO and UI is effective in enhancing leaf biomass per plant in corn
2. Combination of Urea+LCO+NBPT is effective in increasing average leaf dry weight when compared to Urea+UI alone at the concentrations of 800 ppm of UI.

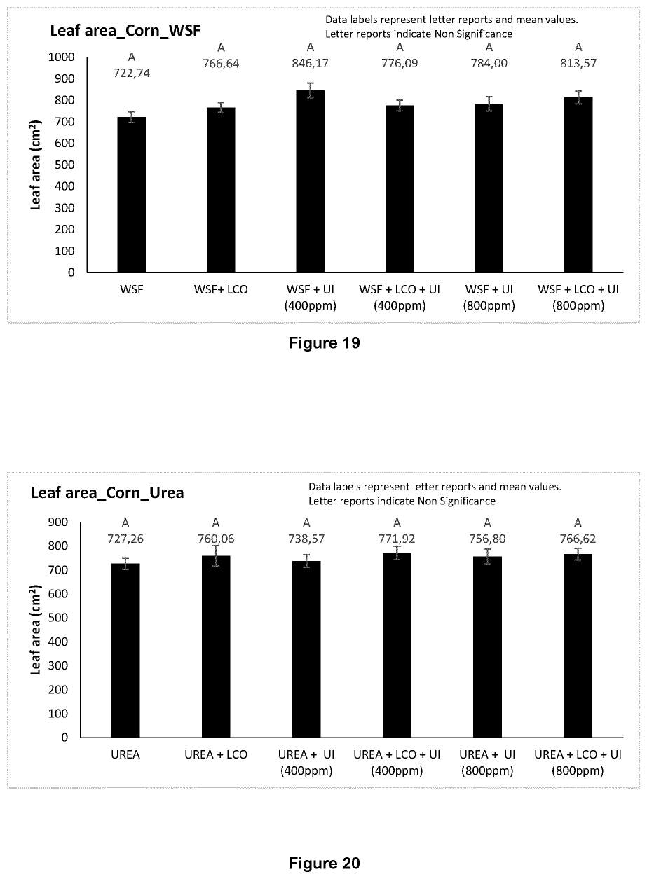

FIG. 19 shows:

1. The combination of WSF, LCO and UI has positive influence in enhancing leaf area in corn
2. Combination of WSF+LCO+NBPT is effective in increasing average leaf area when compared to WSF+UI alone at the concentrations of 800 ppm of UI.

FIG. 20 shows:

1. The combination of Urea, LCO and UI is effective in enhancing leaf area per plant in corn
2. Combination of Urea+LCO+NBPT is effective in increasing average leaf area when compared to WSF+UI alone at both concentrations of UI.

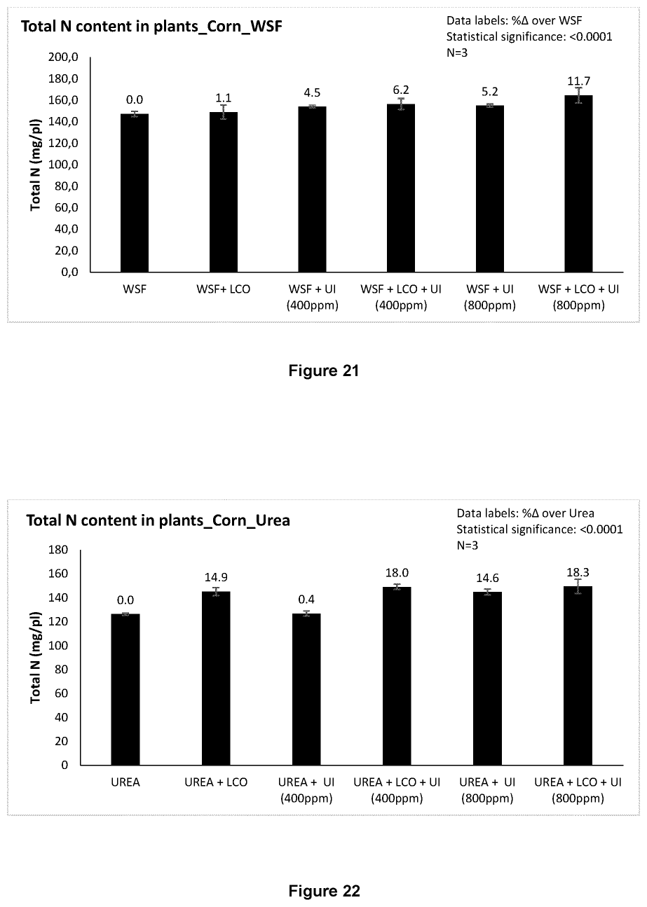

FIG. 21 shows that the combination of WSF, LCO and UI has positive influence in enhancing total nitrogen content in 20 days old corn seedlings.

FIG. 22 shows that the combination of urea, LCO and UI has positive influence in enhancing total nitrogen content in corn.

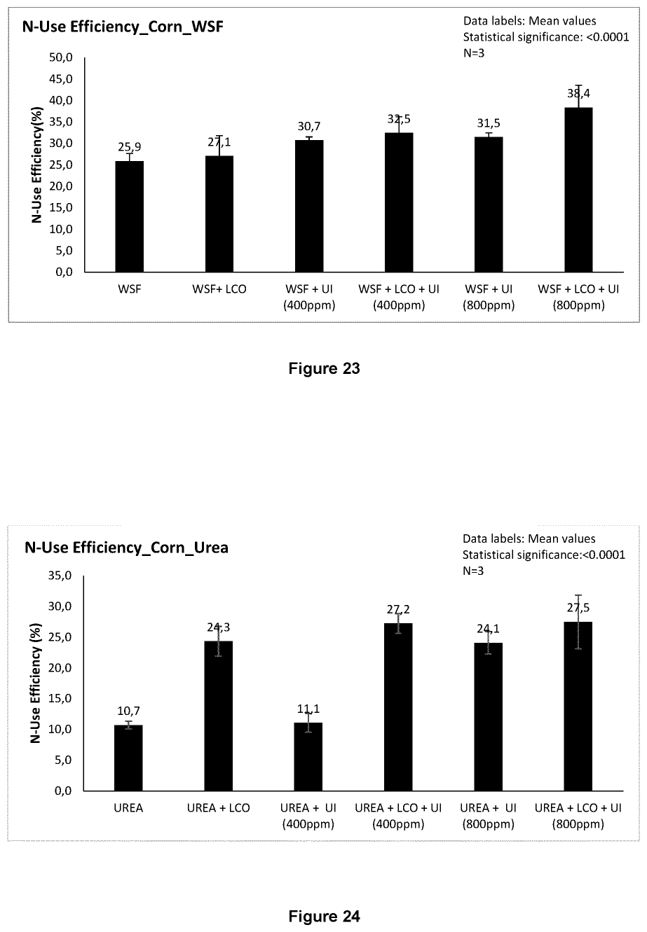

FIG. 23 and FIG. 24 shows that the combination of WSF, LCO and UI and urea, LCO and UI improved the nitrogen use efficiency in corn, respectively.

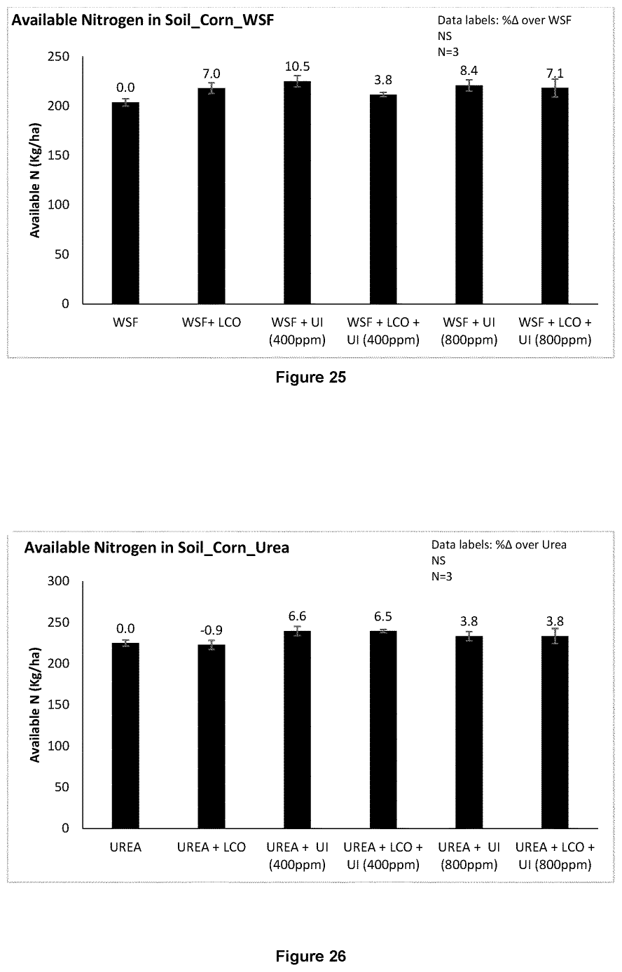

FIG. 25 and FIG. 26 shows that the combination of WSF, LCO and UI and urea, LCO and UI improved the available nitrogen in soil samples from the pots of corn, respectively.

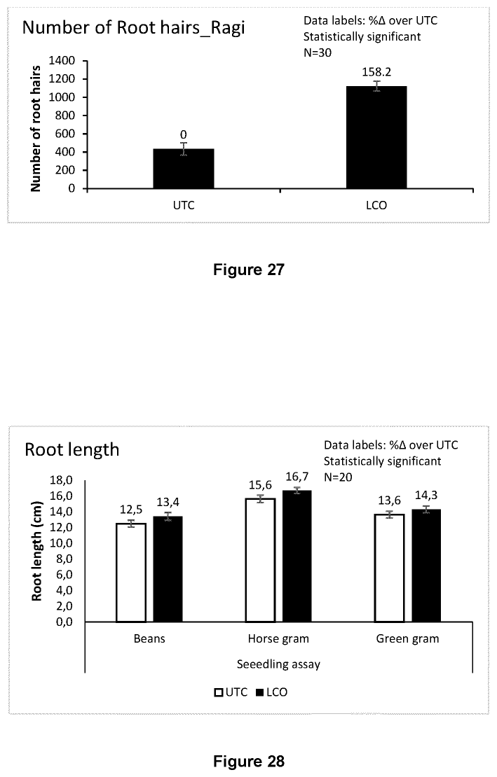

The ability of LCO to increase root hairs is depicted in FIG. 27, where seedlings of finger millet (Eleusine coracana) were treated with LCO and observed after 3 days of treatment.

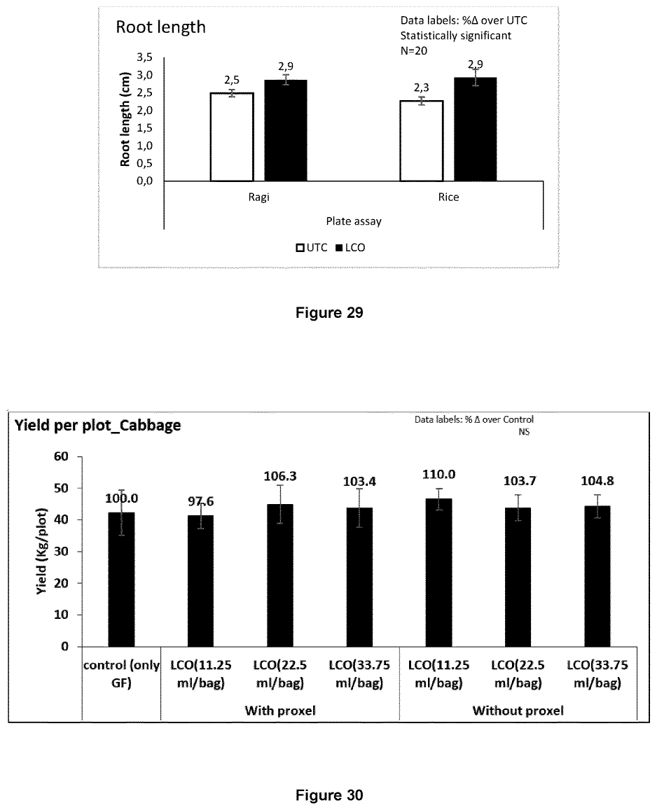

FIG. 28 and FIG. 29 demonstrates LCO increases the length of roots in Beans (Phaseolus vulgaris L), Horse gram (Macrotyloma uniflorum), Green gram (Vigna radiata), Ragi (Eleusine coracana) and Rice (Oryza sativa), when compared to control seedlings without LCO, when observed after 3 days of treatment.

### Conclusion

1. Combining Urea+LCO+NBPT+UI resulted in increased average plant height, average chlorophyll content, average leaf dry weight and average leaf area indicating higher N use efficiency when compared to Urea+UI and Urea alone.
2. Combining Urea+LCO+NBPT+UI resulted in on par performance for root dry weights when compared to with Urea+UI and Urea alone.
3. Combining WSF+LCO+NBPT+UI resulted in increased average plant height, average leaf dry weight and average leaf area indicating higher N use efficiency when compared to WSF+UI and Urea alone.
4. Combining WSF+LCO+NBPT+UI did not result in observable differences in plant height and chlorophyll content compared to WSF alone
5. The preliminary data from this study indicate that combining different fertilizers such as WSF and Urea with LCO and Urease Inhibitor (UI) resulted in better or on par performance for various plant growth parameters when compared to fertilizers alone or fertilizers combined with UI. The positive results clearly indicate that combining Fertilizers+LCO+UI can further enhance N-use efficiency of crops in favourable conditions over and above Fertilizers+UI.
6. The study indicates that combining LCO with UI and Fertilizers does not have any negative effects on plant growth parameters and is therefore a viable combination to extract the value it offers for agriculture in favourable conditions.

WSF used was containing NPK: 19-19-19 (% of each nutrient) and Urea contained 46% Nitrogen (46-0-0). Application of Urease inhibitor is relevant for urea as urea has the amide form of nitrogen which goes through ammonification. Urea (COCNH) form of nitrogen usually undergoes a three-step change before nitrogen is taken up by crops. First, urease enzymes in the soil or plant residue convert the urea nitrogen to ammonia nitrogen and carbon dioxide. The ammonia reacts with soil water to form ammonium nitrogen. Ammonia gas escapes leading to loss of nitrogen. Application of urea inhibitor helps in inhibiting the ammonification. NBPT inhibits the urease enzyme by competitive inhibition: The urea inhibitor-NBPT resembles urea and binds to the active site of the urease enzyme, preventing urea from binding, thereby delaying urea hydrolysis. Given this knowledge, application of UI is not so relevant for WSF having extraordinarily little urea nitrogen. The total nitrogen content of WSF is less than half of that of Urea. WSF was used in the study to demonstrate that urea inhibitor is relevant for urea and other types of fertilizers which have less urea nitrogen, due to presence of LCO.

At the end of the pot experiment at 20th day, plant height, leaf area, dry weight of roots and leaves (shoot), soil nitrogen content, leaf nitrogen content measured and analysed to understand the effect of urease inhibitor (UI) and the combination of LCO+UI when combined with urea, in comparison to urea alone.

The data from this study indicate that the combination of fertilizers, LCO and Urease Inhibitor (UI) has positive influence on enhancing plant biomass in corn compared to fertilizer alone. The results imply that the combination works well for urea indicating that the nitrogen use efficiency is effectively improved in the plants which in-turn promotes leaf and root dry matter and leaf area per plant.

Shoot lengths in WSF and urea study as depicted in FIGS. 11 and 12 indicate that all treatments were on par with each other, with slight differences. Similarly, chlorophyll content of leaves in different treatments were on par with each other as shown in FIGS. 13 and 14.

In case of WSF study, differences in treatments were observed for root dry weight only for the treatment with WSF+UI-800 ppm+LCO, which was the highest as in FIG. 15. Since there was no difference WSF, WSF+UI-400 ppm, WSF+UI-800 ppm, it looks like only LCO has worked here. Leaf dry weight and its derivative, leaf area data in FIGS. 17 and 19, indicate that all treatments are slightly better than WSF alone. WSF+UI-400 ppm was highest in both parameters. Wherever WSF was combined with UI and UI+LCO, the leaf dry weight and leaf area was higher compared to WSF and WSF+LCO, indicating that UI+LCO combination is better than WSF+UI. The amount of urea Nitrogen present is small (about 2-3% within the total 19% N) in WSF, UI and UI+LCO and is thus relevant.

In case of urea study, all the treatments were on par with each other, for shoot length, chlorophyll content and root dry weight. Treatment with WSF+LCO resulted in increase in root dry weight as per previous studies. (FIGS. 12, 14 & 16)

Leaf dry weight and leaf area as in FIGS. 18 & 20 indicates that LCO is better than WSF alone. When LCO is combined with UI at 400 or 800 ppm, it shows increased performance over UI-400 and 800 ppm, respectively. This indicates that combination of UI+LCO is better than urease inhibitor alone.

Leaf nitrogen content of corn (shoot) in the urea experiment was estimated by Kjeldahl method at the end of the experiment at 20 DAS. The results are expressed in mg per gram of dried leaf sample from each treatment. Based on the results in FIG. 21, the following inferences were made:
(a) leaf nitrogen content of treatments where WSF was combined either with UI or LCO or both, was higher when compared to WSF alone
(b) leaf nitrogen content of treatments where WSF was combined with both LCO and UI (at both 400 and 800 ppm) was always higher than the combination having Urea+UI (at both 400 and 800 ppm)
(c) When compared to WSF+UI at 400 or 800 ppn, LCO has increased the leaf nitrogen content when combined with UI at both the levels, respectively.

Comparable results were observed for nitrogen use efficiency in FIG. 23. Treatments where LCO was combined with WSF+UI-400 or 800 ppm, exhibited higher nitrogen use efficiency compared to WSF+UI alone at 400 and 800 ppm. This observation clearly indicates that combining WSF with LCO with UI further increases the potential of nitrogen uptake and nitrogen use efficiency in crops, compared to WSF+UI alone, even though WSF has less than 50% of nitrogen compared to urea. Combination of UI+LCO is better than either LCO alone or UI alone, even at lower levels of nitrogen fertilization.

Based on the results in FIG. 22, the following inferences were made:
(a) leaf nitrogen content of treatments where urea was combined either with UI or LCO or all 3 combined, was higher when compared to urea alone
(b) leaf nitrogen content of treatments where urea was combined with both LCO and UI (at both 400 and 800 ppm) was always higher than the combination having Urea and UI (at both 400 and 800 ppm)
(c) LCO has increased the leaf nitrogen content when combined with Urea and the levels are much higher than urea+UI at 400 ppm and equal to urea+UI at 800 ppm
(d) Combining LCO with urea and UI at both levels, increased leaf nitrogen content further when compared to combinations with urea and UI at both levels. This suggests that Corn plants were able to obtain more nitrogen from treatments where urea was combined with UI and LCO when compared to urea+UI only.

Comparable results were observed for nitrogen use efficiency in FIG. 24. Treatments where LCO was combined with Urea+UI-400 or 800 ppm, exhibited higher N-use efficiency compared to Urea+UI alone at 400 and 800 ppm. This observation clearly indicates that combining Urea with LCO and UI further increases the potential of nitrogen uptake and nitrogen use efficiency in crops, compared to Urea+UI alone. Combination of UI+LCO is better than either LCO alone or UI alone.

FIGS. 25 and 26 depict the nitrogen content of soil remaining at the end of the experiment after 20 DAS, for WSF and Urea, respectively. Treatments with urease inhibitor have slightly higher nitrogen content than others, as expected.

The data supports the proven function of urease inhibitor which is to reduce urea losses by inhibiting ammonification and therefore results in more of applied Nitrogen to be present in soil and available to plants. The data further proves that combining LCO with UI further increases the availability and uptake of Nitrogen into plant systems, over and above urease inhibitor. The combination of UI+LCO is better for nitrogen uptake and nitrogen use efficiency of fertilizers, than combining them with UI or LCO alone.

LCO triggers signalling cascades within the plant system upregulating Nitrogen uptake metabolism and concomitantly increasing physiological parameters such as root length, root branching and more importantly increases the number and length of root hairs, enhancing the surface area for nutrient absorption. FIGS. 28 and 29 clearly demonstrates LCO increases the length of roots in Beans (Phaseolus vulgaris L), Horse gram (Macrotyloma uniflorum), Green gram (Vigna radiata), Ragi (Eleusine coracana) and Rice (Oryza sativa), when compared to control seedlings without LCO, when observed after 3 days of treatment. The ability of LCO to increase root hairs is novel and is depicted here in FIG. 27, where seedlings of finger millet (Eleusine coracana) were treated with LCO and observed after 3 days of treatment.

Treatments having Urea+LCO, Urea+UI-400 ppm+LCO and Urea+UI-800 ppm+LCO resulted in significantly higher nitrogen use efficiency when compared to corresponding treatments without LCO (FIG. 22). The data clearly indicates that combining LCO can result in significant incremental increase in nitrogen use efficiency of urea treated with urease inhibitor alone at different doses.

There is no decrease in the activities of LCO or UI, upon combining the two as described in the method. This indicates that both these molecules are compatible, stable and continue to execute their functions when combined in one formulation.

### Example 7: Evaluating the Effects of Fortifying Bulk Granular Fertilizer (BGF) with LCO in Cabbage Field Study

### Background and Objective

Bulk fertilizers are a combination of essential plant nutrients in the available form which were incorporated into the soil by manual or mechanical methods, generally at the time of planting. An additional application of bulk fertilizers grades was provided as top-dressing depending on the need of the crop. This study aims at combining the LCO with the one of the popularly used bulk fertilizer grades with N:P:K-19:19:19 and assess the bio efficiency of the combined product in enhancing the crop growth and yield in cabbage.

### Experiment Details:

The field experiment was conducted at an agricultural farm in Bangalore in Rabi season of 2020. The study was conducted in randomized complete block design with 7 treatments and 7 replications per treatment with each plot measuring approximately 9 m² in area (Table-12 & 13). Cabbage seedlings of a popular variety was used for the trial. Different grades of bulk fertilizers were available in market generally sold in 50 kg packages. The N:P:K-19:19:19 grade bulk fertilizer was used for the current study. Treatments of LCO fortified bulk fertilizer with 3 doses of LCO 11.25 ml, 22.5 ml, and 33.75 ml were formulated per 50 kg bag of fertilizer. The application dose was calculated based on the crop and standard fertilizer recommendation to the select crop. About 50% of calculated quantity of fertilizers were applied to the crop on a per plot basis as basal application at the time of planting and rest of the quantity of each treatment was applied at 40 days after transplanting (DAT).

TABLE 12
Details of the experiment

| S. no. | Experiment details | Crop: Cabbage |
|---|---|---|
| 1. | Plot area | 3 × 3 m² (9 m²) |
| 2. | Season | Rabi (Oct-Jan 2020-21) |
| 3. | Location | BioAg Farm station, Byalahalli |
| 4. | Treatments | 7 |
| 5. | Replications | 7 plots per treatment |
| 6. | Plant spacing | 45 (plant) × 60 (Row) cm |
| 7. | Plant density per plot | 35 |
| 9. | Total no. of pickings | 1 |

TABLE 13
Details of the treatments applied in the experiment.

| | LCO dose optimization | | LCO ml/kg | LCO (ml/50 kg |
|---|---|---|---|---|
| S. No | with BGF | LCO | fertilizer | bag) |
| 1 | Control (only BGF) | | 0 | 0 |
| 2 | Low LCO | With proxel | 0.225 | 11.25 |
| 3 | Medium LCO | | 0.45 | 22.5 |
| 4 | High LCO | | 0.675 | 33.75 |
| 5 | Low LCO | Without | 0.225 | 11.25 |
| 6 | Medium LCO | proxel | 0.45 | 22.5 |
| 7 | High LCO | | 0.675 | 33.75 |

### Results:

The crop was harvested in January 2021, approximately about 60 days after transplanting, when the matured heads reached the desired size by cutting each head from its base. The yield per plot was measured by weighing all the heads harvested from each plot. The vertical and horizontal diameter of the head was measured using a measuring tape and the volume of each cabbage head was calculated by the following formula V=4/3·π·(a)²·b
Where,
V=Volume of the head
a=Horizontal diameter of the head
b=Vertical diameter of the head

FIG. 30 represents that cabbage yield per plot treated with bulk fertilizer 19:19:19 combined with LCO at the rate of 11.25, 22.5 and 33.75 ml per 50 kg bag. (data represented as Kg/plot). The data labels at the top of each bar represents the percent change where the control plots without LCO was normalized to 100%. Proxel is a biocide added to protect LCO.

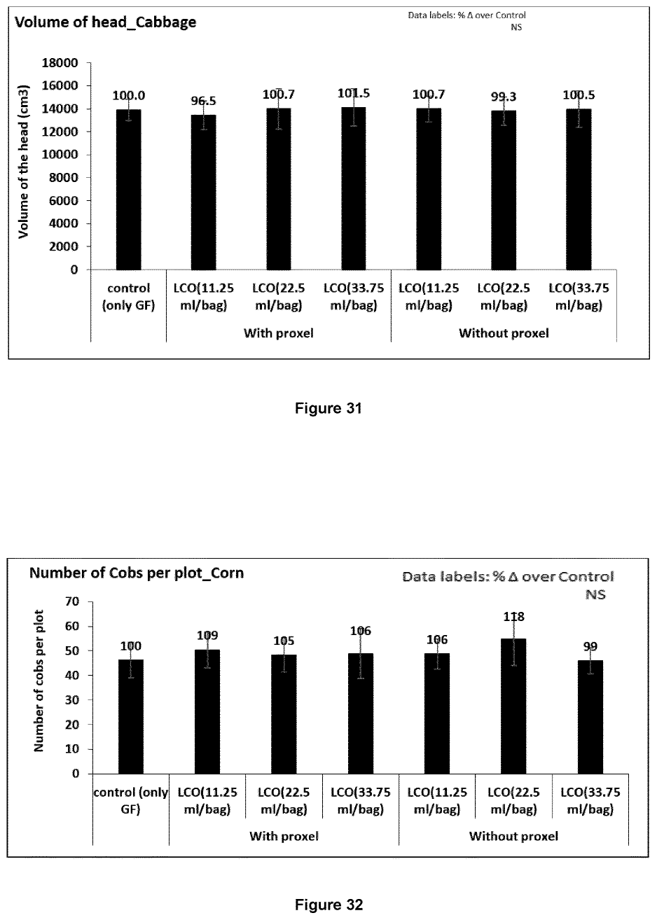

FIG. 31 represents average head volume of cabbages in the plots treated with bulk fertilizer 19:19:19 combined with LCO at the rate of 11.25, 22.5 and 33.75 ml per 50 kg bag. (data represented as cm³ per head). The data labels at the top of each bar represents the percent change where the control plots without LCO was normalized to 100%. Proxel is a biocide added to protect LCO.

### Conclusion:

1. Combining LCO with bulk fertilizer was effective in enhancing the yield of cabbage crop over and above the untreated bulk fertilizer by 6-10%.
2 LCO enhanced average volume of cabbage heads in treatments where bulk fertilizer was combined with LCO, compared to fertilizer alone.
3. When bulk fertilizers are combined at optimum dose, LCO clearly leads to higher crop yields indicating higher nutrient use efficiency per unit of fertilizer applied.

### Example 8: Evaluating the Effects of Fortifying Bulk Granular Fertilizer with LCO in Corn Field Study

### Background and Objective

An additional application of bulk fertilizers grades may be provided as top-dressing depending on the need of the crop. This project aims at combining the LCO with the one of the popularly used bulk fertilizer grades with N:P:K-19:19:19 and assess the bio efficiency of the combined product in enhancing the crop growth and yield in cabbage.

### Experimental Details:

The field experiment was conducted at an agricultural farm in Bangalore in Rabi season of 2020. The study was conducted as randomized complete block design with 7 treatments with 9 replications and each plot measured about 9 m² in area. Hybrid corn seeds of a popular brand was used for the trial. Different grades of Bulk fertilizers are available in market generally sold in 50 kg packages. The N:P:K-19:19:19 grade bulk fertilizer was used for the current study. Bulk fertilizer was combined with 3 doses of LCO at the rate of 11.25 ml, 22.5 ml, and 33.75 ml per 50 kg bag of fertilizer. The application dose was calculated based on the crop and standard fertilizer recommendation to the select crop. About 50% quantity of the treatments were applied to the crop as basal application at the time of planting and rest of the quantity for each treatment was applied at 40 DAS.

TABLE 14
Details of the experiment

| S. No. | Experiment details | Crop: Corn |
|---|---|---|
| 1. | Plot area | 3 × 3 m² (9 m²) |
| 2. | Season | Rabi (Oct-Jan 2020-21) |
| 3. | Location | BioAg Farm station, Byalahalli |
| 4. | Treatments | 7 |
| 5. | Replications | 9 plots per treatment |
| 6. | Plant spacing | 30 (plant) × 60 (Row) cm |
| 7. | Plant density per plot | 50 |
| 9. | Total no. of pickings | 1 |

TABLE 15
Details of the treatments applied in the experiment.

| T | LCO dose optimization | | LCO ml/kg | LCO ml/50 |
|---|---|---|---|---|
| No | with BGF | LCO | fertilizer | kg fertilizer |
| T1 | control (only BGF) | | 0 | 0 |
| T2 | Low LCO | With | 0.225 | 11.25 |
| T3 | Medium LCO | proxel | 0.45 | 22.5 |
| T4 | High LCO | | 0.675 | 33.75 |
| T5 | Low LCO | Without | 0.225 | 11.25 |
| T6 | Medium LCO | proxel | 0.45 | 22.5 |
| T7 | High LCO | | 0.675 | 33.75 |

### Results:

The trial was harvested in January 2021, when the cobs were fully matured. The yield parameters such as number of cobs per plot and cob yield per plot were recorded. The number of cobs per plot was normalized based on plant density per plot. The cobs of each plot were threshed separately and grain weight per plot was recorded and interpreted as Kg per plot normalized to number of plants per plot.

FIG. 32 represents number of cobs per plot treated with bulk fertilizer 19:19:19 combined with LCO at the rate of 11.25, 22.5 and 33.75 ml per 50 kg bag (data represented as count per plot). The data labels at the top of each bar represents the percent change where the control plots without LCO was normalized to 100%. Proxel is a biocide added to protect LCO.

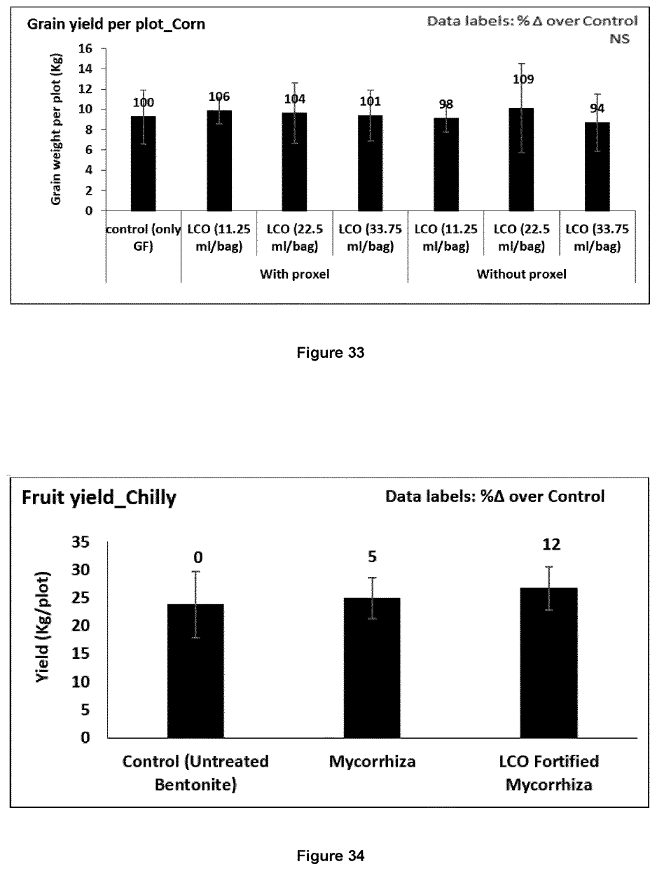

FIG. 33 represents grain yield per plot treated with bulk fertilizer 19:19:19 combined with LCO @ 11.25, 22.5 and 33.75 ml per 50 kg bag. (Data represented as Kg/plot). The data labels at the top of each bar represents the percent change where the control plots without LCO was normalized to 100%. Proxel is a biocide added to protect LCO.

### Conclusion:

1. Combining LCO with bulk fertilizer was effective in enhancing the yield of corn crop over and above the untreated bulk fertilizer by 6-9%.
2. LCO enhanced average number of cobs per plot and grain yield per plot in treatments where bulk fertilizer was combined with LCO, compared to fertilizer alone.
3. When bulk fertilizers are combined at optimum dose, LCO clearly leads to higher crop yields indicating higher nutrient use efficiency per unit of fertilizer applied.

### Example 9: Evaluating the Effects Combining LCO with in-Furrow Applied Microbe—a Mycorrhiza Fungal (Rhizophagus Irregularis) Spores in Chilly (Hot Peppers) Crop in a Field Study

### Background and Objective

LCOs which are signalling molecules play a key role in the symbiotic relationship between plants and mycorrhizal fungi. Combining mycorrhiza with LCO can enhance the infectivity potential and association of the mycorrhiza with the surrounding plant roots. LCO in the soil is perceived by the plant, triggering the activation of a signalling pathway resulting in better and stronger establishment of the mycorrhizal symbiosis and promoting plant nutrition for phosphorus and increasing crop fitness. This experiment aims at combining LCO with the mycorrhizal spores and coating them on carrier bentonite granules and assess its bio-efficiency in enhancing crop growth and yield in chilli crop, in comparison to mycorrhizal spores alone. To help in treatment imposition in field plots, bentonite granules were spray coated with mycorrhiza spores, with and without LCO, and applied to soil at the time of transplanting of chilli seedlings during Kharif season of 2022, at the rate of 4.00 Kg per acre. The yield performance was observed by measuring fresh weight of fruits harvested during multiple pickings until the end of the crop and data was analysed.

### Experiment Details:

The field experiment was conducted at an agricultural farm in Bangalore, as a randomized complete block design with 3 treatments and 8 replications per treatment with each plot having an area of 25 m². Chilly seedlings of a popular variety were used as planting material for the study. The mycorrhiza treatments in the granule formulation @ 4 kg per acre dose were applied to the experimental plots at the time of planting. Inert bentonite granules were applied to the plots to serve as control.

TABLE 16
Details of the experiment

| S. No. | Experiment details | Crop: Chilly |
|---|---|---|
| 1. | Plot area | 5 × 5 m² (25 m²) |
| 2. | Season | Kharif (Jul-Nov 2022) |
| 3. | Location | Bangalore |
| 4. | Treatments | 3 |
| 5. | Replications | 8 plots per treatment |
| 6. | Plant spacing | 50 (plant) × 100 (Row) cm |
| 7. | Plant density per plot | 33 |
| 8. | Total no. of pickings | 9 |

TABLE 17
Details of the treatments applied in the experiment.

| | | Application Dosage | |
|---|---|---|---|
| | | Recommended | Plot size |
| Treatments | | (per acre) | (25 sqm) |
| T1 | Control (Untreated Bentonite) | 4 kg | 250 g |
| T2 | Mycorrhiza | | 250 g |
| T3 | LCO Fortified Mycorrhiza | | |

### Results:

The duration of the crop was 120 days in the current study and gave 9 harvests of chilly fruits. The weight of the fruits harvested in each picking were recorded per plot. The yield per plot is the cumulative yield of the 9 pickings carried out during the trial and averaged across the 8 replications for each treatment.

FIG. 34 represents average chilly fruit yield per plot treated with Mycorrhiza alone and combined with LCO. Plots applied with inert bentonite granules served as control (data represented as Kg/plot). Data labels indicate percent change over control.

### Conclusion:

1. Treatments where mycorrhiza spores were applied with and without LCO, performed better than control with a range of 5-12% yield gain.
2. Combining LCO with Mycorrhizal spores has clearly increased the yield performance of the latter by an extent of 7%.
3. The data provides evidence and supports that combining LCO with microbe, in this case mycorrhizal fungi, enhances efficacy of the microbes to colonize the roots and increases the yield up to 7% over mycorrhiza alone.

### Example 10: Evaluating the Effects of Combining LCO in-Furrow Applied Natural Bio-Stimulant Products Such as Humic Acids, Seaweed Extracts and Amino Acids, Mixed Together in Chilli (Hot Peppers) Crop in a Field Study

### Background and Objective

A field study was conducted to evaluate the beneficial effects of LCO in combination with natural bio-stimulants such as humic acids, seaweed extracts and amino acids, all mixed together, in chilli crop. Since most of these conventional bio-stimulants are commonly used together and to reduce the complexity of the experimentation, all the 3 types of bio-stimulants were combined in equal proportions and then combined with or without LCO. To aid in soil application, the bio-stimulant mix, with and without LCO was spray coated on to roasted bentonite granules.

### Experiment Details:

The field experiment was conducted at an agricultural farm station in Bangalore during Kharif season of 2022. The study was conducted as randomized complete block design with 3 treatments and 8 replications per treatment with each plot measuring 25 m². Chilly seedlings of a popular variety were used as planting material for the study. The bio-stimulant mix, with and without LCO, in granule formulation was applied to the experimental plots at the time of planting at a rate of 4.00 Kg per acre. Inert bentonite granules were applied to the plots marked as control. The details are provided in the Table 18 below.

TABLE 18
Details of the experiment

| S. No. | Experiment details | Crop: Chilly |
|---|---|---|
| 1. | Plot area | 5 × 5 m² (25 m²) |
| 2. | Season | Kharif (Jul-Nov 2022) |
| 3. | Location | Bangalore |
| 4. | Treatments | 3 |
| 5. | Replications | 8 plots per treatment |
| 6. | Plant spacing | 50 (plant) × 100 (Row) cm |
| 7. | Plant density per plot | 33 |
| 8. | Total no. of pickings | 9 |

TABLE 19
Details of the treatments applied in the experiment.

| | | Application Dosage | |
|---|---|---|---|
| | | Recommended | Plot size |
| Treatments | | (per acre) | (25 sqm) |
| T1 | Control (Untreated Bentonite) | 4 kg | 250 g |
| T2 | Bio-stimulant package coated | | 250 g |
| | on bentonite granules | | |
| T3 | LCO Fortified bio-stimulant | | |
| | package coated on | | |
| | bentonite granules | | |

### Results:

The duration of the crop was 120 days in the current study and yielded 9 pickings of chilly fruits. The weight of the fruits harvested in each picking were recorded per plot. The average yield per plot is the cumulative yield of the 9 pickings done in the trial and averaged across 8 replications per treatment.

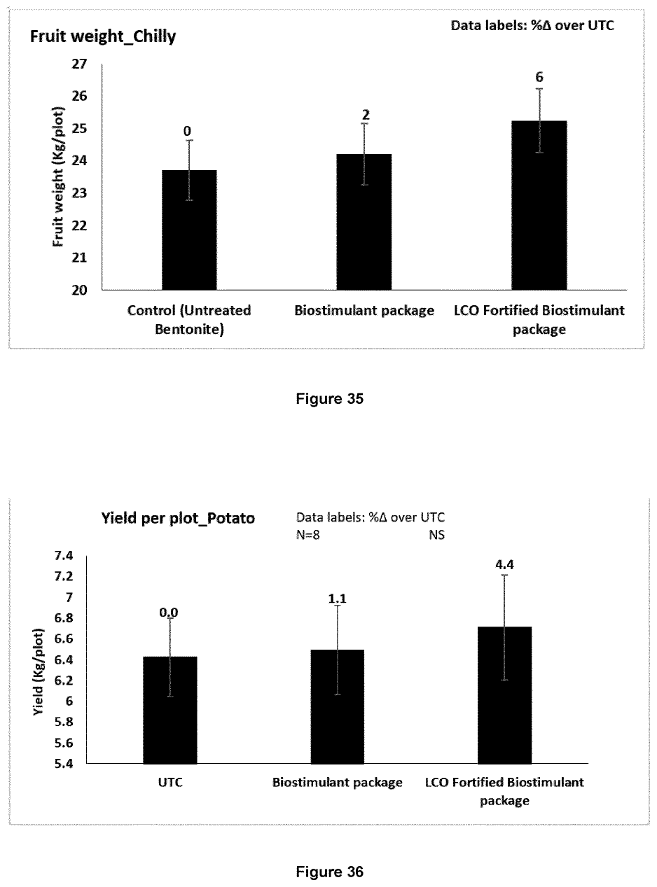

FIG. 35 represents chilly fruit yield per plot treated with bio-stimulant package, LCO fortified bio-stimulant package (data represented as Kg/plot). Data labels indicate percent change over control.

### Conclusion:

1. Treatments where bio-stimulant package was applied with and without LCO, performed better than control with a range of 5-12% yield gain.
2. Combining LCO with bio-stimulant package has clearly increased the yield performance of the latter by an extent of 7%
3. The data provides evidence and supports that combining LCO with bio-stimulants such as humic acids, seaweed extracts and amino acids enhances efficacy and increases the yields of crops.

### Example 11: Evaluating the Effects of Combining LCO with in-Furrow Applied Natural Bio-Stimulant Products Such as Humic Acids, Seaweed Extracts and Amino Acids, Mixed Together, in Potato Crop in a Field Study

### Background and Objective

A field study was conducted to evaluate the beneficial effects of LCO in combination with natural bio-stimulants such as humic acids, seaweed extracts and amino acids, all mixed together to form a bio-stimulant package, in Potato crop. Since most of these conventional bio-stimulants are commonly used together and to reduce the complexity of the experimentation, all the 3 types of bio-stimulants were combined in equal proportions and then combined with or without LCO. To aid in soil application, the bio-stimulant mix, with and without LCO was spray coated on to roasted bentonite granules.

### Experiment Details:

The field experiment was conducted at an agricultural farm station in Bangalore during Rabi season of 2022. The study was conducted as randomized complete block design with 3 treatments and 8 replications per treatment with each plot having an area of 12 m². Potato seed tubers of a popular variety was used as planting material for the study. The bio-stimulant package in the granule formulation was applied to the experimental plots at the time of planting at the rate of 4 kg per acre dose. Inert bentonite granules were applied to the plots marked as control.

TABLE 20
Details of the experiment

| Sl.no. | Experiment details | Crop: Potato |
|---|---|---|
| 1. | Plot area | 4 × 3 m² (12 m²) |
| 2. | Season | Rabi (Nov-Feb 2022-23) |
| 3. | Location | Bangalore |
| 4. | Treatments | 3 |
| 5. | Replications | 8 plots per treatment |
| 6. | Plant spacing | 30 (plant) × 45 (Row) cm |
| 7. | Plant density per plot | 70 |
| 9. | Total no. of pickings | 1 |

TABLE 21
Details of the treatments applied in the experiment.

| | | Application Dosage | |
|---|---|---|---|
| | | Recommended | Plot size |
| Treatments | | (per acre) | (25 sqm) |
| T1 | Control (Untreated Bentonite) | 4 kg | 300 g |
| T2 | Bio-stimulant package coated | | 300 g |
| | on bentonite granules | | |
| T3 | LCO Fortified bio-stimulant | | |
| | package coated on | | |
| | betnonite granules | | |

### Results:

The trial was harvested in February 2023, where the potatoes were harvested from individual plots and the yield per plot was recorded.

FIG. 36 represents potato tuber yield per plot treated with bio-stimulant package and LCO fortified bio-stimulant package (data represented as Kg/plot). Data labels indicate percent change over control.

### Conclusion:

1. Treatments where bio-stimulant package was applied with LCO, performed better than control with 4.4% yield gain.
2. Combining LCO with bio-stimulant package has clearly increased the yield performance of the latter in Potato by an extent of 3.3% over bio-stimulant package alone.
3. The data provides evidence and supports that combining LCO with bio-stimulants such as humic acids, seaweed extracts and amino acids enhances efficacy and increases the yields of crops.

### Example 12: Evaluating the Effects of Combining with LCO with in-Furrow Applied Microbial (Mycorrhiza Fungi, Rhizophagus Irregularis) Spores in Potato Crop in a Field Study

### Background and Objective

This experiment aims at combining LCO with the mycorrhizal spores and coating them on carrier bentonite granules and assess its bio-efficiency in enhancing crop growth and yield in chilli crop, in comparison to mycorrhizal spores alone. To help in treatment imposition in field plots, bentonite granules were spray coated with mycorrhiza spores, with and without LCO, and applied to soil at the time of transplanting of chilli seedlings during Kharif season of 2022, at the rate of 4.00 Kg per acre. The yield performance was observed by measuring fresh weight of fruits harvested during multiple pickings until the end of the crop and data was analysed.

### Experiment Details:

The field experiment was conducted at an agricultural farm at Bangalore in Rabi season of 2022. The study was conducted as randomized complete block design with 3 treatments and 8 replications per treatment with each plot having an area of 12 m². Potato seed tubers of a popular variety was used as planting material for the study. The Mycorrhiza spores with and without LCO were spray coated on bentonite granules and the formulation was applied to the experimental plots at 4.0 kg per acre dose at the time of planting. Inert bentonite granules were applied to the plots marked as control.

TABLE 22
Details of the experiment

| S.no. | Experiment details | Crop: Potato |
|---|---|---|
| 1. | Plot area | 4 × 3 m² (12 m²) |
| 2. | Season | Rabi (Nov-Feb 2022-23) |
| 3. | Location | Bangalore |
| 4. | Treatments | 5 |
| 5. | Replications | 8 plots per treatment |
| 6. | Plant spacing | 30 (plant) × 45 (Row) cm |
| 7. | Plant density per plot | 70 |
| 9. | Total no. of pickings | 1 |

TABLE 23
Details of the treatments applied in the experiment.

| | | Application Dosage | |
|---|---|---|---|
| | | Recommended | Plot size |
| Treatments | | (per acre) | (25 sqm) |
| T1 | Control (Untreated Bentonite) | 4 kg | 300 g |
| T2 | Mycorrhizae on Bentonite | | 300 g |
| T3 | LCO Fortified Mycorrhizae on | | |
| | Bentonite | | |

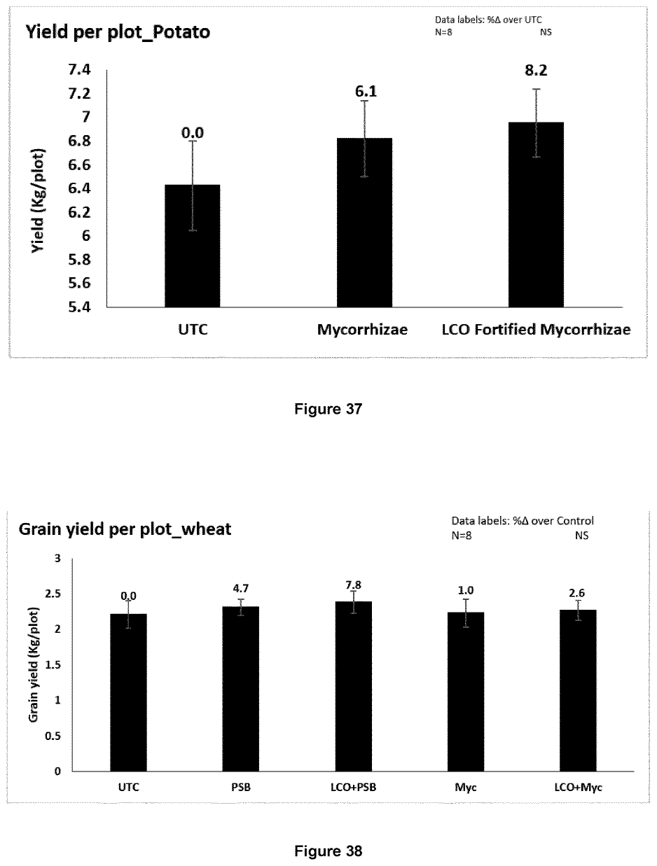

FIG. 37 represents potato tuber yield per plot treated with Mycorrhiza, LCO fortified mycorrhiza (data represented as Kg/plot). Data labels indicate percent change over control.

### Conclusion:

1. Treatments where mycorrhiza spores were applied with and without LCO, performed better than control with a range of 6.1-8.2% yield gain.
2. Combining LCO with Mycorrhizal spores has clearly increased the yield performance of the latter by an extent of ~2.0%.
3. The data provides evidence and supports that combining LCO with microbes, in this case mycorrhizal fungi, enhances efficacy of the microbes to colonize the roots and increases the yield, over and above Mycorrhiza alone.

### Example 13: Evaluating the Effect of Combining LCO with in-Furrow Applied Microbial Combination of Mycorrhiza Fungal Spores (Rhizophagus Irregularis) and a Phosphate Solubilizing Bacteria, PSB (Bacillus megaterium) in Potato Crop in a Field Study

### Background and Objective

The phosphorus solubilizing bacteria helps in releasing the bound form of Phosphorus from bulk soil and in rhizosphere region. Phosphorus released in the rhizosphere region can be easily taken up by plant roots, while Mycorrhizal hyphae helps in mobilizing or transporting the released Phosphorus from the far-off bulk soil directly to the plant root cells via the arbuscular interface.

This experiment aims at combining LCO with more than one microbe viz., mycorrhizal spores and Phosphate solubilizing bacteria (Bacillus megaterium) and coating them on carrier bentonite granules and evaluating its bio-efficacy in enhancing crop growth and yield in Potato crop, in comparison to microbes alone. To help in treatment imposition in field plots, bentonite granules were spray coated with these two microbes, with and without LCO, and applied to soil at the time of transplanting of chilli seedlings during Kharif season of 2022, at the rate of 4.00 Kg per acre. The yield performance was observed by measuring threshed and dried grain weight harvested at the end of the crop and data was analysed.

### Experiment Details:

The study was carried out at an agricultural farm station in Bangalore in Rabi 2022. The study was conducted as randomized complete block design with 5 treatments and 8 replications per treatment with each plot measuring 6 m². A popularly grown Wheat variety was used as seed material for the study. The treatments were applied in the form of seed treatment.

TABLE 24
Details of the experiment

| S.no. | Experiment details | Crop: Wheat |
|---|---|---|
| 1. | Plot area | 3 × 2 m² (6 m²) |
| 2. | Season | Rabi (Nov-Feb 2022-23) |
| 3. | Location | Bangalore |
| 4. | Treatments | 7 |
| 5. | Replications | 8 plots per treatment |
| 6. | Plant spacing | 10 (plant) × 30 (Row) cm |
| 7. | Plant density per plot | 150 |
| 8. | Total no. of pickings | 1 |

TABLE 25
Details of the treatments applied in the experiment.

| | | Recommended Dosage |
|---|---|---|
| S.no. | Treatment Details | (Per Kg of Seeds) |
| 1 | Phosphorus solubilizing bacteria | 0.4 ml |
| 2 | Mycorrhiza | 1.5 g per kg seed |
| 3 | LCO + Phosphorus solubilizing | 0.33 ml + 0.4 ml |
| | bacteria | |
| 4 | LCO + Mycorrhiza | 0.33 ml + 1.5g per kg seed |
| 5 | UTC | — |

### Results:

The trial was harvested in February 2023, and the grain weight per plot was recorded after threshing and drying.

FIG. 38 represents wheat grain yield per plot treated with PSB, Mycorrhiza both individually and combined with LCO (Data represented as Kg/plot). Data labels indicate percent change over control.

### Conclusion:

1. Treatments wherever LCO was combined with mycorrhiza spores or Phosphorus solubilizing bacteria, exhibited better performance when compared to respective individual treatments without LCO.
2 Combining LCO with Mycorrhizal spores has clearly increased the yield performance of the latter by an extent of ~1.6%, over mycorrhiza alone.
3. Combining LCO with Phosphorus solubilizing bacteria spores has clearly increased the yield performance of the latter by an extent of ~3.1% over bacteria alone.
4. The data provides evidence and supports that combining LCO with a combination of more than one microbe, in this case mycorrhizal fungi and Phosphorus solubilizing bacteria, enhances efficacy of the microbes to colonize the roots and increases the yield, over and above individual microbes.

### Example 14: Effect of Fortifying LCO Individually or in Possible Combinations of Bulk Fertilizers, Microbial Consortia and Biostimulant Package in the Corn Greenhouse Study

### Background and Objective

Bulk fertilizers are a combination of essential plant nutrients in the available form which are incorporated into the soil by manual or mechanical methods, generally at the time of planting. An additional application of bulk fertilizers grades may be provided as top-dressing depending on the need of the crop. Fertilizers provide adequate nutrition for plant growth and help farmers achieve the potential yield of a crop variety.

LCOs which are signaling molecules play a key role in the symbiotic relationship between plants and mycorrhizal fungi. LCO in the soil is perceived by the plant, triggering the activation of a signaling pathway resulting in better and stronger establishment of the beneficial symbiotic associations which improves plant nutrition, tolerance to environmental variations and reproductive fitness.

Microbial consortia for NPK nutrients consist of (a) free living nitrogen fixing microbes Azospirillum, Azotobacter, Paenibacillus polymyxa, also known as Bacillus Polymyxa etc., and symbiotic N-fixers such as Rhizobium and Bradyrhizobium species which help in fixing atmospheric Nitrogen gas into ammonia, ammonium and subsequently into nitrate and nitrite forms by other associated bacteria. (b) Phosphorus solubilizing microbes such as Bacillus megaterium, Penicillium bilaiae etc., which helps in releasing the bound form of Phosphorus from minerals and organic matter in rhizosphere space and bulk soil. Phosphorus released in the rhizosphere region can be easily taken up by plant roots, while Mycorrhizal hyphae helps in mobilizing or transporting the released Phosphorus from the far-off bulk soil directly to the plant root cells via the arbuscular interface (c) Potassium solubilizing bacteria such as Bacillus mucilaginosus, Acidithiobacillus ferrooxidans, and Paenibacillus spp., etc., (d) microbes which solubilize other nutrients such as Sulphur, Calcium, Iron, etc.

Biostimulant mix, is a mixture of natural or conventional plant growth promoting products such as humic acids, seaweed extracts and amino acids, in effective proportions. Biostimulants mixes are potent agri inputs and widely available across the globe. These help in promoting root growth, increasing chlorophyll content, number of flowers, fruit set and yield.

This experiment aims at combining fertilizers with LCO and then further combining this duo with NPK consortia, biostimulant mix in a sequentially incremental manner, individually or together. To help in treatment imposition in the pots, fertilizer granules were spray coated with LCO and/or with NPK consortia, or biostimulant mix or in different combinations as per the Table-15, given below. The treatments were applied to soil at the time of sowing Corn seeds in pots at a rate of 250 mg, in green house conditions. Corn seedlings were grown for a total of 25 days and vegetative parameters were measured and data was analysed and presented as charts. This experiment was designed to prove if LCO can provide additional benefits to crop growth and biomass when combined with fertilizers, with and without other agri inputs such as microbial consortia, and biostimulant package.

### Experiment Details:

The experiment was conducted in a greenhouse in Bangalore in October 2023. The study was conducted in pots of 8″ size 6 treatments and 20 replications per treatment. A popularly grown Corn variety was used as seed material for the study. The treatments were applied at the time of sowing placed along with the seed. The duration of the study was 25 days.

TABLE 25
Details of the experiment

| S. No. | Experiment details | Crop:Corn |
|---|---|---|
| 1. | Experiment type | Greenhouse pot study |
| 2. | Time and duration | Oct-Nov 2023, 25 Days |
| 3. | Location | Bangalore |
| 4. | Treatments | 6 |
| 5. | Replications | 20 pots per treatment |
| 6. | Plant density per pot | 2 |

TABLE 26
Details of the treatments applied in the experiment

| S. No. | Treatment Details |
|---|---|
| 1 | Bulk fertilizer |
| 2 | Bulk fertilizer + LCO |
| 3 | Bulk fertilizer + NPK consortia |
| 4 | Bulk fertilizer + NPK consortia + LCO |
| 5 | Bulk fertilizer + Biostimulant package |
| 6 | Bulk fertilizer + Biostimulant package + LCO |

### Methods:

The trial was harvested in November 2023. At 25 DAS the plants were harvested from each pot and the shoot, root and leaves were packed separately and dried in hot air oven @ 70° C. for 96 hours. The dry weights of each sample were measured and represented as Shoot, Root and leaf dry weight (g) per plant. Plant height was measured using a scale (cm).

Leaf area was measured as follows.
1. About 50 Leaf discs of known area were cut from Corn leaves (LA1) and oven were oven dried to obtain dry weights (LDW1)
2. At the time of harvest, all the leaves from each Corn plant were harvested separately and dry leaf weight of each plant was recorded (LDW2)
3. Then the total leaf area (TLA) of the plant is calculated as TLA=LA1×DW2/DW1 and represented as cm² per plant.

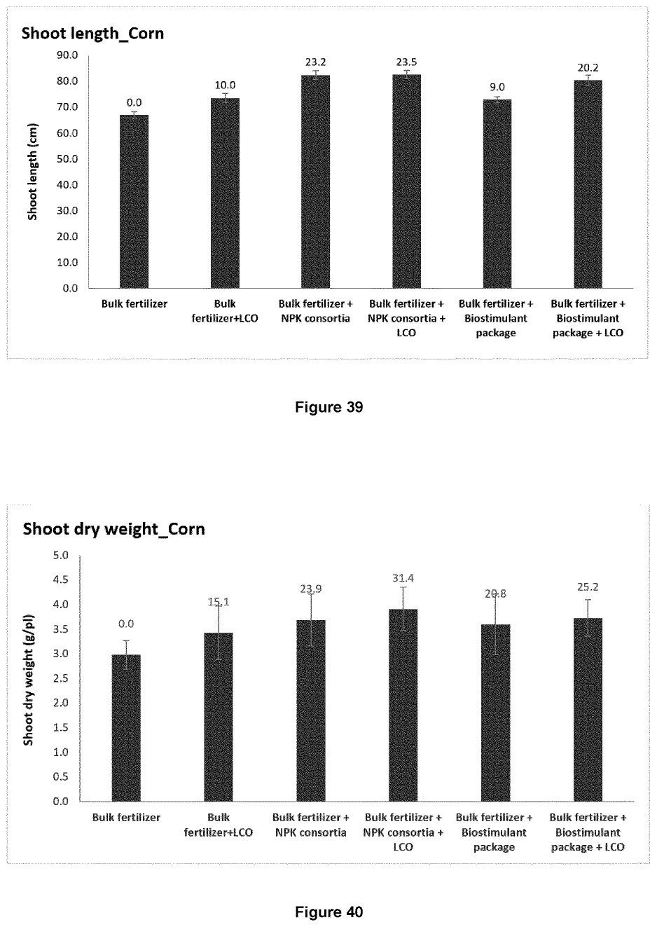

FIG. 39 represents corn shoot length of plants treated with combinations of bulk fertilizer-NPK consortia and bulk fertilizer_biostimulant package with and without LCO (Data represented as cm). Data labels indicate percent change over bulk fertilizer alone.

FIG. 40 represents corn shoot dry weight of plants treated with combinations of bulk fertilizer-NPK consortia and bulk fertilizer_biostimulant package with and without LCO (Data represented as grams per plant). Data labels indicate percent change over bulk fertilizer alone.

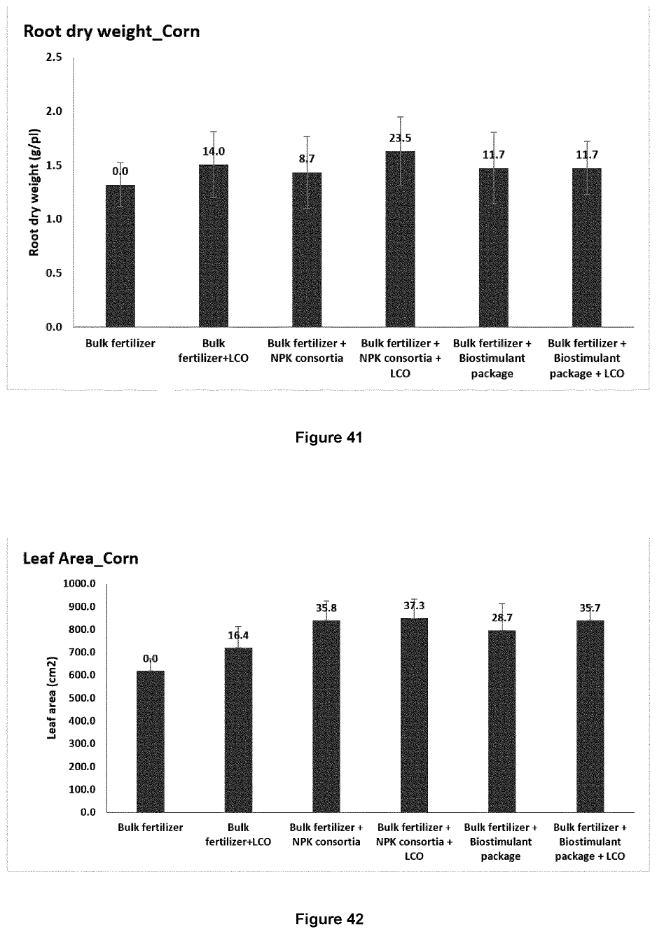

FIG. 41 represents corn root dry weight of plants treated with combinations of bulk fertilizer-NPK consortia and bulk fertilizer_biostimulant package with and without LCO (Data represented as grams per plant). Data labels indicate percent change over bulk fertilizer alone.

FIG. 42 represents corn leaf area of plants treated with combinations of bulk fertilizer-NPK consortia and bulk fertilizer_biostimulant package with and without LCO (Data represented as cm² per plant). Data labels indicate percent change over bulk fertilizer alone.

### Conclusion:

This experiment was designed to evaluate if LCO can provide additional benefits to crop growth and biomass when combined with fertilizers, with and without other agri inputs such as microbial consortia, and biostimulant package.

1. Plants treated with fertilizer alone recorded the lowest values for all the parameters measured indicating that addition of biological inputs such as LCO, microbial consortia or natural biostimulants will help to further increase the fertilizer use efficiency and crop growth performance in real field conditions
2. The combinations of fertilizer+LCO, fertilizer+LCO+microbial consortia and fertilizer+LCO+biostimulant package, clearly exhibited better performance when compared to respective treatments without LCO, viz., fertilizer, fertilizer+microbial consortia and fertilizer+biostimulant package. This indicates that LCO can bring about incremental growth and biomass when used along any other combination of different agricultural inputs and therefore should always be combined with the fertilizers for better nutrient or agricultural input efficiency
3. The combination of fertilizer+LCO resulted in increased shoot length by 10%, shoot dry weight by 15%, root dry weight by 14% and leaf area by 16.4% when compared to its reference fertilizer alone without LCO.
4. The combination of fertilizer+LCO+microbial consortia resulted in increased shoot length by 0.30%, shoot dry weight by 7.5%, root dry weight by 14.8% and leaf area by 1.5% when compared to its reference treatment fertilizer+microbial consortia without LCO
5. The combination of fertilizer+LCO+biostimulant package resulted in increased shoot length by 11.2%, shoot dry weight by 4.4% and leaf area by 7.0% when compared to its reference treatment fertilizer+biostimulant package without LCO

The data provides evidence and supports the claim that fortifying fertilizers with LCO along with or without other agricultural inputs such as microbial consortia and biostimulant package in various combinations, will result in increased plant growth and biomass accumulation leading to improved fertilizer use efficiency.

1-11. (canceled)

12. A method comprising:
(a) preparing a liquid treatment composition comprising one or more lipo-chitooligosaccharides and one or more anti-caking agents; and
(b) applying said treatment composition to a fertilizer.

13. The composition of claim 12, wherein said one or more lipo-chitooligosaccharides comprises a lipo-chitooligosaccharide represented by the structure:

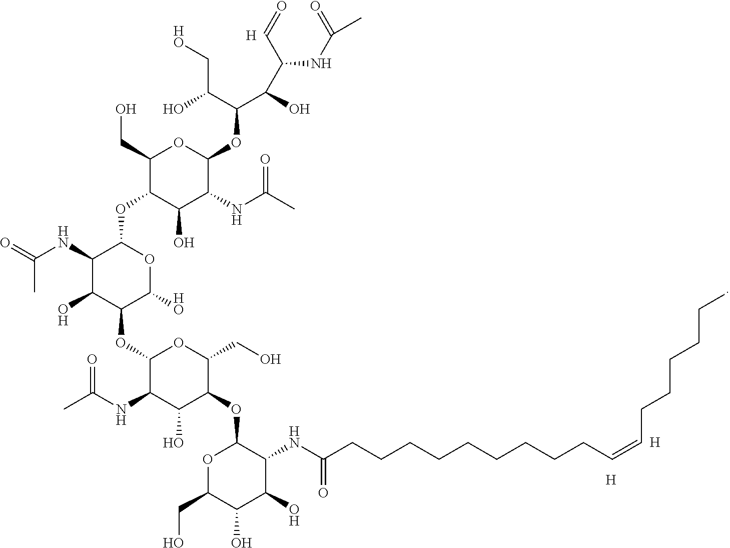

14. The method of claim 12, wherein said treatment composition comprises 0.050-0.150 part per billion of said one or more lipo-chitooligosaccharides.

15. The method of claim 12, wherein said treatment composition comprises 0.050-0.150 part per billion of a lipo-chitooligosaccharide represented by the structure:

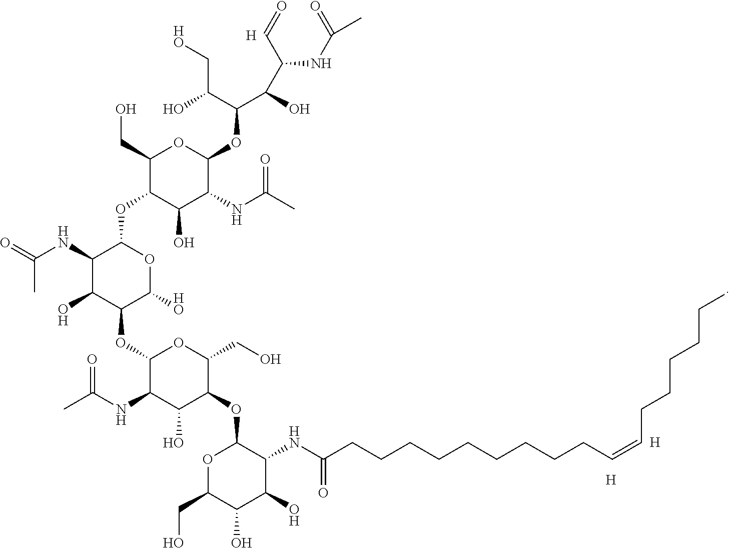

16. The composition of claim 12, wherein said one or more anti-caking agents comprises an anti-caking agent selected from tricalcium phosphate, powdered celluloses, magnesium stearate, sodium bicarbonate, sodium ferrocyanide, potassium ferrocyanide, calcium ferrocyanide, calcium phosphate, sodium silicate, silicon dioxide, calcium silicate, magnesium trisilicate, talcum powders, sodium aluminosilicate, potassium aluminium silicate, calcium aluminosilicate, bentonite, aluminium silicate, stearic acid, polydimethylsiloxane, slack waxes and mineral oils.

17. The composition of claim 12, wherein said one or more anti-caking agents comprises one or more fatty amines.

18. The composition of claim 12, wherein said treatment composition comprises about 0.5 to about 4 kg of anti-caking agent per ton of said fertilizer.

19. The composition of claim 12, wherein said treatment composition comprises at least 2 kg of anti-caking agent per ton of said fertilizer.

20. The composition of claim 12, wherein said treatment composition further comprises one or more urease inhibitors.

21. The composition of claim 12, wherein said one or more urease inhibitors comprises N-(n-butyl) thiophosphoric triamide (NBPT).

22. The composition of claim 12, wherein said one or more urease inhibitors comprises N-(n-propyl) thiophosphoric triamide (NPPT).

23. The composition of claim 12, wherein said treatment composition comprises 400-800 part per million of said one or more urease inhibitors.

24. The composition of claim 12, wherein said treatment composition further comprises one or more microorganisms.

25. The composition of claim 12, wherein said treatment composition further comprises one or more biostimulants.

26. The composition of claim 12, wherein said treatment composition further comprises one or more pesticides.

27. The composition of claim 12, wherein said fertilizer is a water-soluble fertilizer.

28. The composition of claim 12, wherein said fertilizer is a granular fertilizer.
